(19) United States
(12) Patent Application Publication
(10) Pub. No.: US 2010/0216963 A1
(43) Pub. Date: Aug. 26, 2010

(54) CYCLOOLEFIN RESIN FILM AND PROCESS FOR PRODUCING THE SAME

(75) Inventor: Tadashi Ueda, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/680,518

(22) PCT Filed: Sep. 16, 2008
(86) PCT No.: PCT/JP2008/066652

§ 371 Date: Mar. 26, 2010

(30) Foreign Application Priority Data
Sep. 28, 2007 (JP) 2007-256756

(51) Int. Cl. C08F 10/00; D01D 5/16

(52) U.S. Cl. 526/348.1; 264/210.2

(57) ABSTRACT

A process for producing a cycloolefin resin film which comprises: a step in which a cycloolefin resin is melt-extruded at an extrusion temperature of 230-260° C. and a melt viscosity of 500-3,000 Pa·s into a film through a die; a step in which the melt-extruded film is cast; a step in which the cast film is wound up; and a step in which the film which has been wound is unwound and then stretched in the machine and/or transverse direction to cause retardation. The process is characterized by including the step of molecular orientation before the film winding step.

### TECHNICAL FIELD

The present invention relates to a cycloolefin resin film and a process for producing the same, and particularly relates to a cycloolefin resin film which is used for a liquid crystal display device, and to a process for producing the same.

### BACKGROUND ART

A cellulose-based resin film such as a cellulose acylate film is formed by melting a cellulose-based resin and extruding the melt to a die with an extruder, discharging the melted resin into the form of a sheet from the die, and cooling and solidifying the discharged sheet to form a film. The formed cellulose-based resin film is stretched in a longitudinal (length) direction and a transverse (width) direction to develop retardation (Re) in the plane and retardation (Rth) in the thickness direction, and is used as a phase difference film of a liquid crystal display element. The widening of a viewing angle is thus implemented (see Patent Document 1, for instance).

Because the cycloolefin resin film can improve the hygroscopicity and the water vapor permeability of the cellulose-based resin film, the cycloolefin resin film has received attention in recent years, as a film having optical properties less sensitive to the change in the environmental temperature and humidity. It has been investigated to use the cycloolefin resin films which are formed by melt-extrusion film-formation and solution casting film-formation, as films for a polarizing plate and a liquid crystal display (see Patent Documents 2 and 3, for instance).

Patent Document 1: Japanese National Publication of International Patent Application No. 6-501040

Patent Document 2: Japanese Patent Application Laid-Open No. 2005-43740

Patent Document 3: Japanese Patent Application Laid-Open No. 2002-114827

### DISCLOSURE OF THE INVENTION

### Problems to be Solved by the Invention

It is generally conducted in a process for producing a cycloolefin resin film to form an optical film by producing an unstretched intermediate base film and stretching the intermediate base film in a longitudinal direction and/or a transverse direction to develop retardation in the intermediate base film.

However, the intermediate base film which includes the cycloolefin resin film as a main component has had a problem that when the intermediate base film is stretched in a longitudinal direction and/or a transverse direction so as to develop the retardation, the intermediate base film is ruptured because of being brittle.

The present invention is designed with respect to such a circumstance, and is directed at improving the brittleness of the unstretched intermediate base film, stably producing a cycloolefin resin film and enhancing the production efficiency.

### Means for Solving the Problems

In order to achieve the above-described object, A method for producing a cycloolefin resin film comprising the steps of: melt-extruding a cycloolefin resin into a form of a film from a die, at an extrusion temperature of 230 to 260° C. and a melt viscosity of 500 to 3,000 Pa·s; casting the melt-extruded film; winding the cast film; and unwinding the wound film and stretching the film in a longitudinal direction and/or a transverse direction to develop retardation therein, wherein the method comprises a molecular orientation treatment step before the step of winding the film.

The cycloolefin resin film is amorphous, but by being subjected to the orientation treatment, the molecules are arranged along the longitudinal direction of the film. The film in which the molecules have been orientated acquires strengthened brittleness. The intermediate base film having acquired the strengthened brittleness can be transported without being ruptured and can be wound with a winder. Furthermore, in the case where the intermediate base film is stretched in the longitudinal direction and/or the transverse direction so as to develop retardation therein, the intermediate base film is hardly ruptured even by being held by a tenter or the like, or by being stretched in a longitudinal direction with rollers having different peripheral velocities. As a result, the production efficiency of the cycloolefin resin film is enhanced.

The method for producing a cycloolefin resin film according to a second aspect of the present invention is characterized in that the molecular orientation treatment step in the first aspect is a step of stretching the melt-extruded film at a stretch ratio of 1.05 to 2.5 times in the longitudinal direction.

A molecular orientation treatment is applied to the melt-extruded film by stretching the film at the stretch ratio of 1.05 to 2.5 times in the longitudinal direction (Machine Direction: MD). As a result, the brittleness of the film is improved. The ratio of the longitudinal stretching is preferably 1.05 to 2.5 times. The ratio is more preferably 1.07 to 2.0 times, and particularly preferably is 1.08 to 1.5 times.

The method for producing a cycloolefin resin film according to a third aspect of the present invention is characterized in that the stretching of the film in the longitudinal direction in the second aspect is conducted in the casting step. The method does not need to provide a separate stretching step because stretching of the film in a longitudinal direction is performed with the cooling roller which is used in the casting step to orientate the molecules. Accordingly, the existing production facility can be used efficiently.

The method for producing a cycloolefin resin film according to a fourth aspect of the present invention is characterized in that the stretching of a film in the longitudinal direction comprises heating the melt-extruded film with a heating roller whose temperature is in a range of Tg+10 to Tg+200° C.

The operation of heating the film with the heating roller which has been heated to the temperature range of Tg+10 to Tg+200° C. can inhibit the retardation from developing when the film is stretched in the longitudinal direction to orientate the molecules.

The method for producing a cycloolefin resin film according to a fifth aspect of the present invention is characterized in that the temperature distribution in a width direction of the heating roller in the fourth aspect is within ±2° C.

The heating roller can uniformly heat the film in the width direction, and accordingly can more effectively inhibit the retardation from developing.

The method for producing a cycloolefin resin film according to a sixth aspect of the present invention is characterized in that the method for producing a cycloolefin resin film according to any one of the first to fifth aspects comprises further heating the melt-extruded film with a far-infrared heater.

Since the melt-extruded film is heated with the infrared heater, a leveling effect develops on the drum, which makes the surface approximately uniform. As a result, the film-thickness distribution of the obtained film reduces, and a die streak thereof decreases.

The method for producing a cycloolefin resin film according to a seventh aspect of the present invention is characterized in that the method in any one of the first to sixth aspects includes an embossing step of further imparting an embossed pattern having a height in a range of 5 to 20% of a thickness of the film, to the film which has been subjected to the molecular orientation treatment.

The film can be easily embossed because the strength of the film is increased by the molecular orientation treatment. In addition, the film can be stably wound because the embossed pattern is imparted thereto.

The method for producing a cycloolefin resin film according to an eighth aspect of the present invention is characterized in that the embossing step in the seventh aspect is a step of imparting an embossed pattern to the film by heating an embossing roller to a temperature range of Tg+10 to Tg+200° C. A load applied to the film in the embossing step can be reduced by setting the temperature of the embossing roller to a range of Tg+10 to Tg+200° C. and heating the film.

The method for producing a cycloolefin resin film according to a ninth aspect of the present invention is characterized in that the embossing roller in the eighth aspect is heated by a heater.

The method for producing a cycloolefin resin film according to a tenth aspect of the present invention is characterized in that the heater in the ninth aspect is an infrared heater or a dielectric-heating heater. The tenth aspect specifies a preferable method of heating the embossing roller.

The method for producing a cycloolefin resin film according to an eleventh aspect of the present invention is characterized in that the method in any one of the first to tenth aspects includes a pass roller for supporting the film, of which the surface roughness (Ra) is 1 μm or less. The film can be transported without scratching the surface of the film by setting the surface roughness (Ra) of the pass roller for supporting the film at 1 μm or less.

The method for producing a cycloolefin resin film according to a twelfth aspect of the present invention is characterized in that the step of casting the melt-extruded film in any one of the first to eleventh aspects is any one of a touch roll system, an air chamber system, a vacuum nozzle system, an electrostatic application system and an air knife system. The above-described casting systems can be preferably applied to the present invention.

The method for producing a cycloolefin resin film according to a thirteenth aspect of the present invention is characterized in that, in the method according to any one of the first to twelfth aspects, the step of casting the melt-extruded film comprises casting the film with a casting drum having a surface roughness (Ra) of 30 μm or less. The film can be stably cast by using the casting drum having the surface roughness (Ra) of 30 μm or less.

A cycloolefin resin film according to a fourteenth aspect of the present invention is characterized in that the film is produced by the process according to any one of the first to thirteenth aspects. The cycloolefin resin film according to the fourteenth aspect can be preferably applied to the applications because of having improved brittleness.

### ADVANTAGES OF THE INVENTION

According to a method for producing a cycloolefin resin film according to the present invention, since a molecular orientation treatment step is performed, the occurrence of a rupture of a film can be decreased when the film is in a state of an unstretched intermediate base film. Accordingly, the cycloolefin resin film can be stably produced, and the production efficiency can be enhanced.

### BRIEF DESCRIPTION OF THE DRAWINGS

FIG. 1A is a block diagram of a film production apparatus to which the present invention is applied;

FIG. 1B is a block diagram of another film production apparatus to which the present invention is applied;

FIG. 2 is a schematic view illustrating a structure of an extruder; and

FIG. 3 is a schematic view illustrating a structure of a roller (embossing roller) for stretching the film.

### DESCRIPTION OF SYMBOLS

10—Production apparatus
12A—Ethylene-norbornene copolymerized resin film
12B—Intermediate base film
12C—Optical film
14—Extruder
16—Die
18—First cooling roller
20—Second cooling roller
22—Third cooling roller
24—Peeling roller
26—Winder
30—Production apparatus
32—Feeder
34—Longitudinal stretching section
36 and 38—Nip rollers
40—Transverse stretching section
42—Winder

### BEST MODE FOR CARRYING OUT THE INVENTION

A process for producing a cycloolefin resin film of the present invention will be described in detail below. The present invention will be described below with reference to preferable embodiments, but can be modified by many techniques without exceeding the scope of the present invention, and can make use of other embodiments than the present embodiment. Accordingly, all modifications in the range of the present invention are included in the claims. The range of numerical values expressed by using “to” in the present specification hereafter means the range including the numerical values which are described prior and posterior to “to”.

Incidentally, in the present embodiment, an example of producing an ethylene-norbornene copolymerized resin film (TOPAS MD6013 made by Polyplastics Co., Ltd.) will be described, but the present invention is not limited to the present embodiment, and can be applied to a process for producing a film by using cycloolefin resin other than the ethylene-norbornene copolymerized resin.

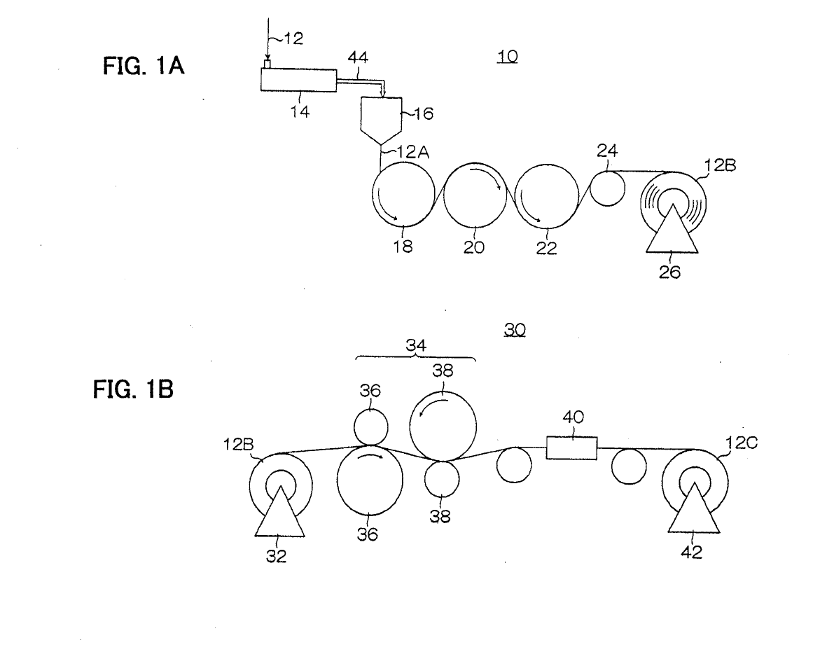

As is illustrated in FIG. 1A, a production apparatus 10 is mainly constituted by: an extruder 14 for melting an ethylene-norbornene copolymerized resin 12; a die 16 for melt-extruding the melted ethylene-norbornene copolymerized resin 12 into the form of a film; a plurality of cooling rollers 18, 20 and 22 which cool the hot ethylene-norbornene copolymerized resin film 12A (hereinafter referred to as a film 12A) after having been discharged from the die 16, in multi-stages; a peeling roll 24 for peeling the film 12A from the last cooling roll 22; and a winder 26 for winding the cooled film 12A. In the step of FIG. 1A, the cooled film 12A is wound by the winder 26, and an intermediate base film 12B is produced as a material for an optical film.

The ethylene-norbornene copolymerized resin 12 which has been melted by the extruder 14 is sent to the die 16 through a pipe 44, and is discharged from the discharge port of the die 16 into the form of a film. A pressure for discharging the ethylene-norbornene copolymerized resin 12 to be discharged from the die 16 is preferably controlled to a fluctuation range within 10%.

Next, the hot film 12A which has been discharged from the die 16 is cooled in the multi-stage with the three cooling rollers 18, 20 and 22 which are arranged in the multi-stage. Here, the cooling rollers 18, 20 and 22 which are arranged in three stages are referred to as a first cooling roller 18, a second cooling roller 20 and a third cooling roller 22, sequentially from an upstream side in a transport direction of the film.

In such a multi-stage cooling system, in the present invention, the temperature condition of the first cooling roller 18 onto which the hot film 12A that has been discharged from the die 16 lands is set in the following way.

The surface temperature of the first cooling roller 18 is set in a range of a glass transition temperature of the ethylene-norbornene copolymerized resin Tg+10 to Tg+200° C.

(Please write any preferable conditions for orientating molecules in the film.)

The film 12A which has been discharged from the die 16 can be inhibited from being rapidly cooled when landing on the first cooling roller 18, by setting the temperature of the first cooling roller 18 in the range of the glass transition temperature of the ethylene-norbornene copolymerized resin Tg+10 to Tg+200° C., and accordingly can be effectively inhibited from forming a wrinkle in the film 12A when having landed on the first cooling roller.

The film 12A is transported while being cooled and solidified by the first cooling roller 18, the second cooling roller 20 and the third cooling roller 22. At that time, the peripheral velocities of the first cooling roller 18, the second cooling roller 20 and the third cooling roller 22 are set so as to increase toward the downstream side. As a result, the film 12A is stretched in a longitudinal direction (length direction) according to the velocity difference between each of the cooling rollers 18, 20 and 22, and is stretched at a stretch ratio of preferably 1.05 to 2.5 times. The stretch ratio is more preferably 1.07 to 2.0 times, and particularly preferably is 1.08 to 1.5 times.

The molecular orientation treatment is applied to the film 12A by the operation of stretching the film 12A in a longitudinal direction with the cooling rollers 18, 20 and 22. The rupture strength of the intermediate base film 12B to be produced is improved by the operation of casting the film 12A with cooling rollers of multi-stage to cool and solidify the film 12A, and simultaneously applying the molecular orientation treatment to the film 12A.

In the present embodiment, the film 12A is heated with the first cooling roller 18 of which the surface temperature has been set at the glass transition temperature Tg+10 to Tg+200° C. This enables to prevent the film 12A from forming a wrinkle therein, and to inhibit the film 12A from developing the retardation therein when stretching in a longitudinal direction is performed by using the difference in peripheral speed among the first cooling roller 18, the second cooling roller 20 and the third cooling roller 22. When the film 12A is stretched in a longitudinal direction without being heated, the retardation develops in the film 12A which will become the intermediate base film. When the retardation once develops in the intermediate base film, desired optical properties may not be obtained even when the film is stretched in a longitudinal direction and/or a transverse direction so as to obtain actual optical properties. When the film 12A is stretched so as to orientate the molecules therein, it is important to inhibit the retardation from developing.

The surface temperature T1 of the first cooling roller 18 and the film temperature T2 when the film comes in contact with the first cooling roller 18 may be grasped by being measured beforehand through a preliminary test or the like, or may be controlled by providing a non-contact type of temperature measurement instrument such as an infrared emission thermometer on the production apparatus and automatically controlling the temperature of a medium for the cooling roller on the basis of the measurement result.

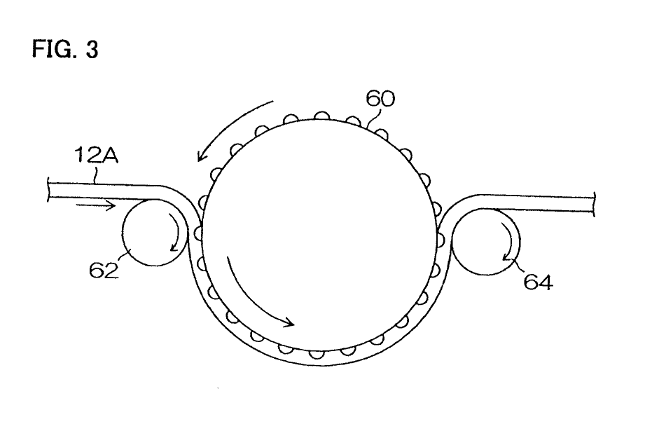

An embossing roller 60 is provided in between the peeling roller 24 and the winder 26 (see FIG. 3), in order to apply embossing treatment to the film 12A. A regular fine concavo-convex pattern is formed on a peripheral face of the embossing roller 60. The regular fine concavo-convex pattern is transcribed onto the film 12A. The embossing roller 60 is required to have the precision of the concavo-convex pattern, the mechanical strength, the circularity and the like. Such an embossing roller 60 is preferably a roller made from metal.

A method to be adopted for forming the regular fine concavo-convex pattern on the peripheral face of the embossing roller 60 includes: a method of cutting a surface of the embossing roller 60 with a turning diamond tool (single point); and a method of directly forming the concavo-convexness on a surface of the embossing roller 60 with a photo etching technique, an electron beam lithography, a laser machining technique or the like.

The surface of the embossing roller 60 is preferably subjected to mold release treatment. The shape of the fine concavo-convex pattern can be adequately maintained by thus applying the mold release treatment to the surface of the embossing roller 60. The mold release treatment can adopt well-known various methods, for instance, a treatment of coating the embossing roller 60 with a fluororesin.

A nip roller 62 is provided on a position opposing to the embossing roller 60. The film 12A is pressed by the embossing roller 60 and the nip roller 62, and the concavo-convex shape of the embossing roller 60 is transcribed onto the film 12A.

In addition, a pressure device is preferably provided on any one of the embossing roller 60 and the nip roller 62 so as to impart a predetermined pressing force between the embossing roller 60 and the nip roller 62.

A peeling roller 64 is provided so as to oppose to the embossing roller 60 in the opposite side with respect to the nip roller 62. The peeling roller 64 has a function of peeling the film 12A from the embossing roller 60 while cooperating with the embossing roller 60.

The embossing roller 60 imparts an embossed pattern having the height of 5 to 20% of the thickness of the film 12A, to the film 12A which has been subjected to the molecular orientation treatment. The film 12A does not rupture even when being subjected to embossing treatment, because of having been subjected to the molecular orientation treatment to acquire improved brittleness. The film 12A can be stably wound because the embossed pattern is imparted thereon.

The embossing roller 60 is heated to be in a range of Tg+10 to Tg+200° C. by a heater (not shown in the drawing). A load applied to the film 12A in the embossing step can be reduced by setting the temperature of the embossing roller 60 to a range of Tg+10 to Tg+200° C. and heating the film.

An infrared heater or a dielectric-heating heater can be preferably used as a heater for heating the embossing roller 60.

Next, an intermediate base film 12B which has been produced by the production apparatus 10 is stretched in a longitudinal direction and a transverse direction with a production apparatus 30 to develop retardation (Re) in the plane and retardation (Rth) in the thickness direction, which have properties required to an optical film.

As is illustrated in FIG. 1B, the production apparatus 30 includes: a feeder 32 for feeding an intermediate base film 12B; a longitudinal stretching section 34 for stretching the intermediate base film 12B in a longitudinal direction; a transverse stretching section 40 for stretching the intermediate base film 12B which has been longitudinally stretched, in a transverse direction; and a winder 42 for winding the intermediate base film 12B which has been transversely stretched. In the step of FIG. 1B, the intermediate base film 12B is wound by the winder 42, and an optical film 12C is produced.

The stretching operation for the intermediate base film 12B is conducted in order to orientate the molecules in the intermediate base film 12B and develop the retardation (Re) in the plane and the retardation (Rth) in the thickness direction. Here, the retardations Re and Rth are determined by the following expressions:

Re(nm)=|n(MD)−n(TD)|×T(nm); and

Rth(nm)=|{(n(MD)+n(TD))/2}−n(TH)|×T(nm),

wherein
n (MD: Machine Direction), n (TD: Transverse direction) and n (TH) represent refractive indices in a longitudinal direction, a width direction and a thickness direction; and T represents the thickness expressed in the unit of nm (nanometer).

As is illustrated in FIG. 1B, the intermediate base film 12B is longitudinally stretched in a longitudinal direction at first, in the longitudinal stretching section 34. In the longitudinal stretching section 34, the intermediate base film 12B is preheated. Then, the intermediate base film 12B in a state of having been heated is pulled through two nip rollers 36 and 38. The nip roller 38 in the downstream side transports the intermediate base film 12B at a faster peripheral velocity than that of the nip roller 36 in the upstream side. The intermediate base film 12B is stretched in the longitudinal direction by a difference in peripheral speed between the two nip rollers 36 and 38.

The intermediate base film 12B which has been stretched in a longitudinal direction is sent to the transverse stretching section 40, and is transversely stretched in the width direction of the intermediate base film 12B. A tenter, for instance, can be preferably used for the transverse stretching section 40. The retardation Rth can be further increased by holding both ends of the intermediate base film 12B in the width direction with a clip of the tenter and stretching the film in the transverse direction.

The intermediate base film 12B after having been stretched is wound by the winder 42 in FIG. 1B into the form of a roll, and the optical film 12C is produced.

In the present invention, when the intermediate base film is produced, molecule orientation is applied to the intermediate base film by stretching the intermediate base film in the longitudinal direction, thereby improving the brittleness of intermediate base film. The stretching operation in a longitudinal direction when the intermediate base film is produced can be replaced with the longitudinal stretching operation for developing the retardation by controlling the stretching condition. In other words, it is possible to make the stretching operation in a longitudinal direction in the production of the intermediate base film have both functions of improving the brittleness and longitudinal stretching for developing the retardation necessary in the next step. The stretching step in a longitudinal direction can be omitted, which has been originally necessary for developing the retardation.

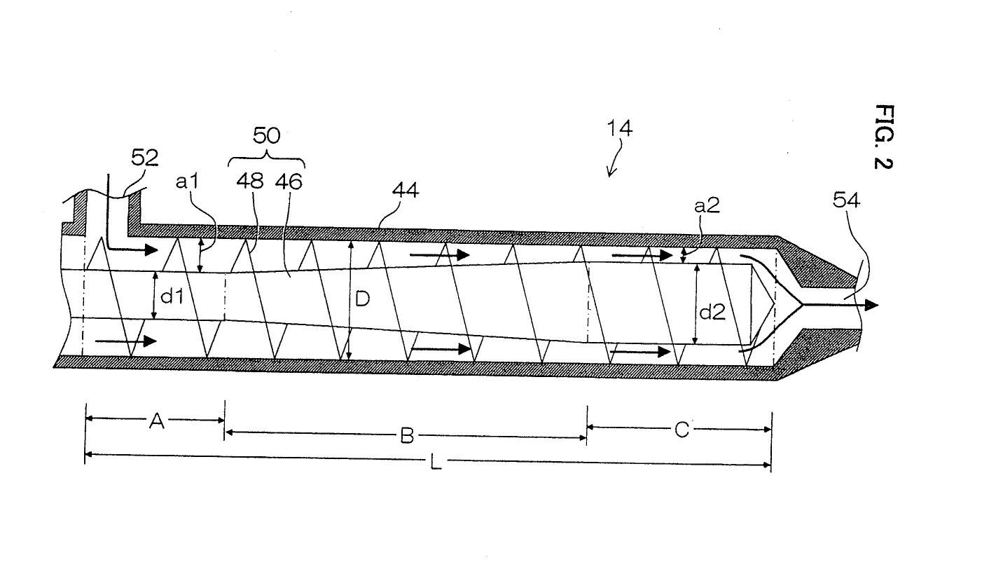

FIG. 2 illustrates a structure of the extruder 14. As is illustrated in the same figure, a single axis screw 50 which has a flight scraper 48 attached on a screw shaft 46 is provided in a cylinder 44 of the extruder 14. The single axis screw 50 is structured so as to be rotated by a motor (not shown in the drawing). A hopper (not shown in the drawing) is installed on a supply port 52 of the cylinder 44. The ethylene-norbornene copolymerized resin is supplied to the cylinder 44 from this hopper through the supply port 52.

The inner part of the cylinder 44 comprises sequentially from the supply port 52 side: a supply section (region shown by A) for quantitatively transporting the ethylene-norbornene copolymerized resin which has been supplied from the supply port 52; a compressing section (region shown by B) for kneading and compressing the ethylene-norbornene copolymerized resin; and a metering section (region shown by C) for weighing the kneaded and compressed ethylene-norbornene copolymerized resin. The ethylene-norbornene copolymerized resin which has been melted in the extruder 14 is continuously transported to the die from a discharge port 54.

The screw compression ratio of the extruder 14 is preferably set at 2.5 to 4.5, and L/D is preferably set at 20 to 70. Here, the screw compression ratio is expressed by a volume ratio of a supply section A to a metering section C, in other words, by a volume of the supply section A per unit length divided by a volume of the metering section C per unit length, and is calculated by using an outer diameter d1 indicating the screw shaft 46 in the supply section A, an outer diameter d2 indicating the screw shaft 46 in the metering section C, a diameter a1 indicating the groove part indicating the supply section A and a diameter a2 indicating the groove part of the metering section C. In addition, L/D is a ratio of a length (L) of the cylinder with respect to an inner diameter (D) of the cylinder in FIG. 2.

The extrusion temperature is set at 230 to 260° C. The melt viscosity of the film 12A to be discharged from the die 16 is set at 500 to 3,000 Pa·s. In particular, the present invention is directed at stably conducting a stretching step for improving the brittleness of a cycloolefin resin having the above-described properties of the extrusion temperature and the melt viscosity, and developing retardation therein.

(Cycloolefin Resin)

In the present invention, a cycloolefin resin is also referred to as a cyclic polyolefin. The cycloolefin resin means a polymer resin having a cyclic olefin structure. Examples of the polymer resin having the cyclic olefin structure include (1) norbornene-based polymer, (2) polymer of a monocyclic olefin, (3) polymer of a cyclic conjugated diene, (4) polymer of a vinyl alicyclic hydrocarbon, and a hydride of (1) to (4). A preferable polymer to the present invention is an addition (co)polymer of a cyclic polyolefin, which contains at least one of a repeating unit represented by the following general formula (II), and an addition (co)polymer of a cyclic polyolefin, which further contains at least one of a repeating unit represented by a general formula (I), as needed. A ring-opening (co)polymer which contains at least one of a cyclic repeating unit represented by a general formula (III) can also be preferably used.

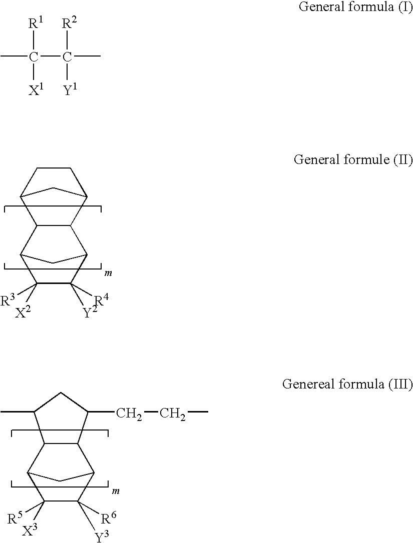

In the general formulae (I), (II) and (III), m represents an integer of 0 to 4. R¹ to R⁶ each independently represents a hydrogen atom or a hydrocarbon group having a carbon number of 1 to 10. X¹ to X³ and Y¹ to Y³ each independently represents: a hydrogen atom; a hydrocarbon group having a carbon number of 1 to 10; a halogen atom; a hydrocarbon group having a carbon number of 1 to 10 in which a halogen atom substitutes for a hydrogen atom; —(CH₂)ₙCOOR¹¹; —(CH₂)ₙOCOR¹²; —(CH₂)ₙNCO; —(CH₂)ₙ—NO₂; —(CH₂)ₙCN; —(CH₂)ₙCONR¹³R¹⁴; —(CH₂)ₙNR¹³R¹⁴; —(CH₂)ₙOZ; —(CH₂)ₙW; or (—CO)₂O or (—CO₂)NR¹⁵ which is constituted by X¹ and Y¹, X² and Y², or X³ and Y³. In addition, R¹¹, R¹², R¹³, R¹⁴ and R¹⁵ each independently represents a hydrogen atom or a hydrocarbon group having a carbon number of 1 to 20; Z represents a hydrocarbon group or a hydrocarbon group in which a halogen atom substitutes for a hydrogen atom; W represents SiR¹⁶ₚD₃₋ₚ(R¹⁶ represents a hydrocarbon group having a carbon number of 1 to 10; D represents a halogen atom, —OCOR¹⁶ or —OR¹⁶; and p represents an integer of 0 to 3); and n represents an integer of 0 to 10.

A functional group having large polarizability is introduced to all or some substituents of X¹ to X³ and Y¹ to Y³. Thereby, the optical film can increase the retardation (Rth) in the thickness direction, and can increase the developing way of the retardation (Re) in the plane. The film having a large Re developing way can acquire a large Re value by being stretched in a film-forming step.

A norbornene-based addition (co)polymer is disclosed in Japanese Patent Application Laid-Open No. 10-7732, Japanese National Publication of International Patent Application No. 2002-504184, US 2004229157A1, WO 2004/070463A1 and the like. The norbornene-based addition (co)polymer can be obtained by addition-polymerizing norbornene-based polycyclic unsaturated compounds with each other. In addition, the norbornene-based addition (co)polymer can be obtained, as needed, by addition-polymerizing a norbornene-based polycyclic unsaturated compound with: ethylene, propylene or butene; a conjugated diene such as butadiene and isoprene; a non-conjugated diene such as ethylidene norbornene; or a linear diene compound such as acrylonitrile, acrylic acid, methacrylic acid, maleic anhydride, an acrylic ester, a methacrylic ester, maleimide, vinyl acetate and vinyl chloride. This norbornene-based addition (co)polymer comes on the market with a trade name of APEL (trade mark) from Mitsui Chemicals, Inc, which has some grades having different glass transition temperatures (Tg) such as APL8008T (Tg of 70° C.), APL6013T (Tg of 125° C.) and APL6015T (Tg of 145° C.), for instance. The pellet such as TOPAS8007, TOPAS6013 and TOPAS6015 comes on the market from Polyplastics Co., Ltd. Furthermore, Appear3000 comes on the market from Ferrania Technologies S.p.A.

A hydride of the norbornene-based polymer is prepared by addition-polymerizing or metathesis-ring-opening polymerizing a polycyclic unsaturated compound, and adding hydrogen thereto, as is disclosed in Japanese Patent Application Laid-Open No. 1-240517, Japanese Patent Application Laid-Open No. 7-196736, Japanese Patent Application Laid-Open No. 60-26024, Japanese Patent Application Laid-Open No. 62-19801, Japanese Patent Application Laid-Open No. 2003-1159767, Japanese Patent Application Laid-Open No. 2004-309979 and the like. In the norbornene-based polymer which is used in the present invention, R⁵ to R⁶ are each preferably a hydrogen atom or —CH₃; X³ and Y³ are each preferably a hydrogen atom, Cl or —COOCH₃; and other groups are appropriately selected. This norbornene-based resin comes on the market with a trade name of Arton G or Arton F from JSR Corporation, and comes on the market with a trade name of Zeonor ZF 14, ZF16, Zeonex 250 or Zeonex 280 from ZEON CORPORATION, which can be used.

(Additive)

In a production process according to the present invention, various additives (antidegradant, ultraviolet-rays inhibitor, retardation (optical anisotropy) modifier, particulates, peeling promoter and infrared-absorption agent, for instance) can be added to a cyclic polyolefin solution according to the application in various preparation steps. The additives may be a solid or an oily matter. In other words, the melting point and the boiling point are not limited in particular. For instance, ultraviolet absorption materials of 20° C. or lower and 20° C. or higher are mixed, and antidegradants are mixed in a similar way. Furthermore, the infrared-absorption dye is described in Japanese Patent Application Laid-Open No. 2001-194522, for instance. In addition, the additives may be added in any step during preparing a cyclic polyolefin solution (dope), and the step of adding the additives in the last preparation step of the dope-preparing steps and preparing the dope may be added. Furthermore, the amount of each material to be added is not limited in particular as long as the function develops. When the cyclic polyolefin film is formed from a multilayer, the type and the amount of additives in each layer may be different from each other.

(Antidegradant)

In a production process of the present invention, a well-known degradation (oxidization) inhibitor, for instance, a phenol-based or hydroquinone-based antioxidant such as 2,6-di-t-butyl, 4-methylphenol, 4,4′-thiobis-(6-t-butyl-3-methylphenol), 1,1′-bis(4-hydroxyphenyl)cyclohexane, 2,2′-methylenebis(4-ethyl-6-t-butylphenol), 2,5-di-t-butylhydroquinone, pentaerythrityl-tetrakis[3-(3,5-di-t-butyl-4-hydroxyphenyl)propionate can be added to the cyclic polyolefin solution. Furthermore, a phosphorus-based antioxidant such as tris(4-methoxy-3,5-diphenyl) phosphite, tris(nonylphenyl) phosphite, tris(2,4-di-t-buthylphenyl) phosphite, bis(2,6-di-t-butyl-4-methylphenyl)pentaerythritol diphosphite and bis(2,4-di-t-butylphenyl)pentaerythritol diphosphite is preferably added to the cyclic polyolefin solution. The amount of the antioxidant to be added is preferably in a range of 0.05 to 5.0 parts by mass with respect to 100 parts by mass of the cyclic polyolefin.

(UV Absorber)

In a production process of the present invention, a UV absorber is preferably used for the cyclic polyolefin solution from the view point of preventing the degradation of a polarizing plate, a liquid crystal or the like. The UV absorber to be preferably used little absorbs a visible light having a wavelength of 400 nm or longer, from the viewpoint of showing a superior capability of absorbing ultraviolet rays having the wavelength of 370 nm or shorter and showing good liquid crystal display performance. Specific examples of the UV absorber which is preferably used in the present invention include, for instance, a hindered phenol-based compound, an oxybenzophenone-based compound, a benzotriazol-based compound, a salicylate-based compound, a benzophenone-based compound, a cyanoacrylate-based compound and a nickel complex salt-based compound. Examples of the hindered phenol-based compound include 2,6-di-tert-butyl-p-cresol, pentaerythrityl-tetrakis[3-(3,5-di-tert-butyl-4-hydroxyphenyl)propionate], N,N′-hexamethylene bis(3,5-di-tert-butyl-4-hydroxy-hydrocinnamide), 1,3,5-trimethyl-2,4,6-tris(3,5-di-tert-butyl-4-hydroxybenzyl)benzene, and tris-(3,5-di-tert-butyl-4-hydroxybenzyl)-isocyanurate. Examples of the benzotriazol-based compound include 2-(2′-hydroxy-5′-methylphenyl)benzotriazol, 2,2-methylene bis(4-(1,1,3,3-tetramethylbutyl)-6-(2H-benzotriazol-2-yl)phenol), 2,4-bis-(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylene bis(3,5-di-tert-butyl-4-hydroxy-hydrocinnamide), 1,3,5-trimethyl-2,4,6-tris(3,5-di-tert-butyl-4-hydroxybenzyl)benzene, 2(2′-hydroxy-3′,5′-di-tert-buthylphenyl)-5-chlorobenzotriazol, (2(2′-hydroxy-3′,5′-di-tert-amylphenyl)-5-chlorobenzotriazol, 2,6-di-tert-butyl-p-cresol, and pentaerythrityl-tetrakis[3-(3,5-di-tert-butyl-4-hydroxyphenyl)propionate]. The amount of these ultraviolet inhibitors to be added is preferably in a range of 1 ppm to 1.0% by a mass ratio with respect to the cyclic polyolefin, and more preferably is 10 to 1,000 ppm.

(Particulate of Matting Agent)

Next, a matting agent which is used in the present invention will be described below. In order to improve poor sliding properties of the film face, it is effective to impart convexo-convex to a film surface, and a method is known which adds particulates of organic and/or inorganic substance to the film, and thereby increases the roughness of the film surface, so-called, makes the surface matte to decrease the adhesiveness of the film.

In the present invention, a matting agent is added into the film to be produced, and thereby the dispersion of the optical properties can be improved, which is formed by the in-plane dispersion of the tension in the film, which originates in a low modulus of elasticity or the like of the film and occurs in a transportation step.

In order to inhibit the surface from being excessively roughened to prevent the haze from increasing and to maintain the transparency, it is preferable to control the average particle size and the content of the matting agent to the range which will be described below.

The average particle size of the matting agent described in the present invention means an average size of the matting agent existing in the film or on the film, and can be determined from the average value of particle sizes of 100 particles, which have been obtained from SEM photographs and TEM photographs of a surface and a section of the film, regardless of whether the matting agent is an aggregate or a non-aggregate.

The matting agent which is used in the present invention is preferably an inorganic compound particle or a polymer particulate having an average particle size of 0.1 μm to 3.0 μm, more preferably of 0.15 μm to 2.0 μm, and most preferably of 0.2 μm to 1.0 μm.

The average particle size of the matting agent described in the present invention means an average particle size of aggregates (average secondary particle size) when the matting agent is an agglutinative particulate. When the matting agent is produced with a solution casting film-forming method, the average particle size can be controlled with a dispersion method which will be described later, as a particle size in the dispersion liquid. When the matting agent is the non-agglutinative particulate, the average particle size means an average value of sizes measured for each one particle.

The matting agent which is used in the present invention is preferably particulates having an average primary particle size of 0.05 μm to 0.5 μm, more preferably of 0.08 μm to 0.3 μm, and most preferably of 0.1 μm to 0.25 μm, when the matting agent is the agglutinative particulate.

The polymer particulate can provide a desired refractive index by selecting the polymer type. Furthermore, the polymer particulate has high compatibility with a cycloolefin resin, and can suppress the haze, the refraction and the scattering to low values when the film using the polymer particulate is formed. Accordingly, when the polymer particulate is used as the matting agent, the matting effect can be enhanced by selecting a grade of a larger size than that of the case in which an inorganic particulate is used as the matting agent.

In addition, the content is preferably 0.03 to 1.0 mass %, more preferably is 0.05 to 0.6 mass % and most preferably is 0.08 to 0.4 mass %, regardless of whether the matting agent has a spherical shape or an indefinite shape, and is an inorganic particulate or a polymer, for instance.

The haze of the cycloolefin resin film containing the matting agent in the present invention is preferably in a range of 4.0% or less, more preferably of 2.0% or less, and most preferably of 1.0% or less. The value of the haze was obtained by measuring a sample of 40 mm×80 nm with a haze meter (HGM-2DP, Suga Test Instruments) at 25° C. and 60% RH, according to JIS (Japanese Industrial Standards) K-6714.

The static coefficient of friction of the cycloolefin resin film in which the matting agent has been added is preferably 0.8 or less, and particularly preferably is 0.5 or less.

The composition of the matting agent to be used is not limited in particular, and these matting agents can be also used in the form of two or more of them being mixed. The inorganic compound for the matting agent in the present invention includes, for instance, a fine powder of an inorganic substance such as barium sulfate, manganese colloid, titanium dioxide, strontium barium sulfate and silica dioxide, further, for instance, a silicon dioxide which is a synthetic silica obtained by a wet method or a gelation of silicic acid, and a titanium dioxide (rutile type and anatase type) which is produced from a titanium slug and sulfuric acid. The inorganic compound of the matting agent can be obtained also by pulverizing an inorganic substance having a comparatively-large particle size, for instance, such as 20 μm or more, and classifying (oscillating filtration, air classification or the like) the obtained particles. The inorganic compound for the matting agent in the present invention includes also an inorganic compound of which the surface has been modified with a methyl group or a hydroxyl group.

The polymer compound (polymer particulate) includes polytetrafluoroethylene, cellulose acetate, polystyrene, polymethylmethacrylate, polypropylmethacrylate, polymethyl acrylate, polyethylene carbonate, starch, and a pulverized and classified substance thereof. A polymer compound can be alternatively used which has been synthesized with a suspension polymerization method, or a polymer compound or an inorganic compound can be alternatively used which has been formed into a spherical shape with a spray dry method, a dispersion method or the like.

In addition, the polymer compound may also be a polymer compound which has been prepared from a polymer of one or more types of monomer compounds which will be described below and has been formed into particles with various devices. Specific examples of the monomer compound for the polymer compound include an acrylic ester, a methacrylic ester, an itaconic diester, a crotonic ester, a maleic diester and a phthalic diester. The ester residues include groups of methyl, ethyl, propyl, isopropyl, butyl, hexyl, 2-ethylhexyl, 2-chloroethyl, cyanoethyl, 2-acetoxyethyl, dimethylaminoethyl, benzyl, cyclohexyl, furfuryl, phenyl, 2-hydroxyethyl, 2-ethoxyethyl, glycidyl, and co-methoxy polyethylene glycol (with addition number of 9 moles).

Examples of vinyl esters include vinyl acetate, vinyl propionate, vinyl butyrate, vinyl isobutyrate, vinyl caproate, vinyl chloroacetate, vinyl methoxy acetate, vinyl phenyl acetate, vinyl benzoate and vinyl salicylate. Examples of olefins include dicyclopentadiene, ethylene, propylene, 1-butene, 1-pentene, vinyl chloride, vinylidene chloride, isoprene, chloroprene, butadiene and 2,3-dimethylbutadiene.

Styrenes include, for instance, styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, trifluoromethylstyrene and vinylbenzoic acid methyl ester.

Acrylamides include acrylamide, methylacrylamide, ethylacrylamide, propylacrylamide, butylacrylamide, tert-butylacrylamide, phenylacrylamide and dimethylacrylamide; methacrylamides include, for instance, methacrylamide, methylmethacrylamide, ethylmethacrylamide, propylmethacrylamide and tert-butylmethacrylamide; allyl compounds include, for instance, allyl acetate, allyl caproate, allyl laurate and allyl benzoate; vinyl ethers include, for instance, methyl vinyl ether, butyl vinyl ether, hexyl vinyl ether, methoxyethyl vinyl ether and dimethylaminoethyl vinyl ether; vinyl ketones include, for instance, methyl vinyl ketone, phenyl vinyl ketone and methoxyethyl vinyl ketone; vinyl heterocyclic compounds include, for instance, vinylpyridine, N-vinyl imidazole, N-vinyl oxazolidone, N-vinyl triazole and N-vinyl pyrrolidone; unsaturated nitriles include, for instance, acrylonitrile and methacrylonitrile; and polyfunctional monomers include, for instance, divinylbenzene, methylene bis acrylamide and ethylene glycol dimethacrylate.

The monomer compounds further include: acrylic acid, methacrylic acid, itaconic acid, maleic acid, and a monoalkyl itaconate (monoethyl itaconate, for instance); a monoalkyl maleate (monomethyl maleate, for instance); styrene sulfonic acid, vinylbenzyl sulfonic acid, vinyl sulfonic acid, and an acryloyloxyalkyl sulfonic acid (acryloyloxymethylsulfonic acid, for instance); a methacryloyloxyalkylsulfonic acid (methacryloiloxy ethyl sulfonic acid, for instance); an acrylamide alkyl sulfonic acid (2-acrylamide-2-methylethanesulfonic acid, for instance); a methacrylamide alkyl sulfonic acid (2-methacrylamide-2-methylethanesulfonic acid, for instance); and an acryloyloxyalkyl phosphate (acryloyloxyethyl phosphate, for instance). These acids may be salts of an alkali metal (Na and K, for instance) or an ammonium ion. Furthermore, other preferably usable monomer compounds include cross-linkable monomers described in the specifications of U.S. Pat. No. 3,459,790, U.S. Pat. No. 3,438,708, U.S. Pat. No. 3,554,987, U.S. Pat. No. 4,215,195, U.S. Pat. No. 4,247,673, Japanese Patent Application Laid-Open No. 57-205735 and the like. Specific examples of such cross-linkable monomers can include N-(2-acetoacetoxyethyl)acrylamide and N-(2-(2-acetoacetoxyethoxy)ethyl)acrylamide.

These monomer compounds may be used in the form of particles of a polymer which have been solely polymerized, or in the form of particles of a copolymer which is polymerized in combination with a plurality of polymers. Among these monomer compounds, acrylic esters, methacrylate esters, vinyl esters, styrenes and olefins are preferably used. In addition, particles having a fluorine atom or a silicon atom may be used for the present invention, which are described in Japanese Patent Application Laid-Open No. 62-14647, Japanese Patent Application Laid-Open No. 62-17744 and Japanese Patent Application Laid-Open No. 62-17743.

Compositions of the particles to be preferably used among them include polystyrene, polymethyl(meth)acrylate, polyethylacrylate, poly(methyl methacrylate/methacrylic acid=95/5 (molar ratio), poly(styrene/styrenesulfonic acid=95/5 (molar ratio), polyacrylonitrile, poly(methyl methacrylate/ethyl acrylate/methacrylic acid=50/40/10), and silica.

Usable matting agents for the present invention also include particles having a reactive (gelatin, in particular) group described in Japanese Patent Application Laid-Open No. 64-77052 and European Patent No. 307855. Furthermore, the matting agent can also contain a large amount of such groups as to dissolve into an alkaline liquid or an acidic liquid. Specific examples of the matting agent in the present invention will be described below, but are not limited to these examples.

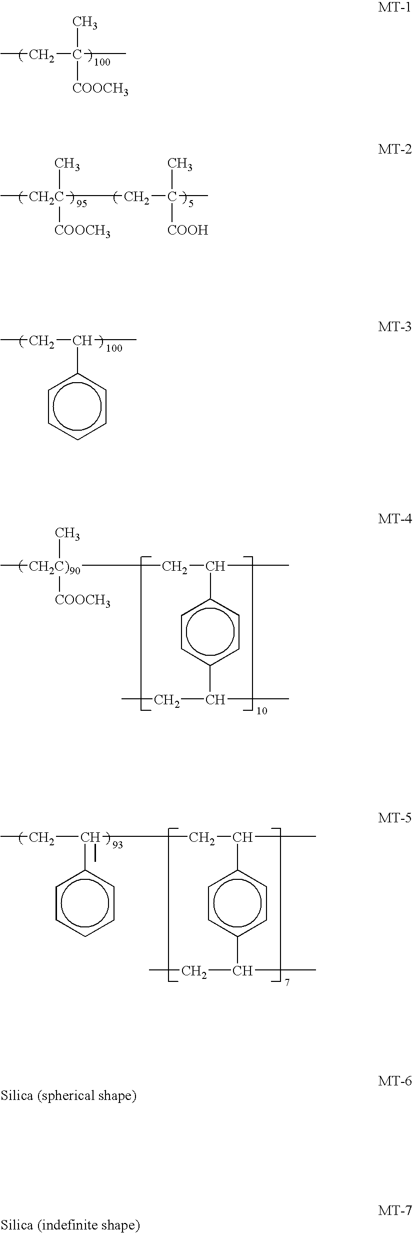

Next, as for a method of incorporating the matting agent into the film, the method is not limited in particular, but includes a method of casting a solution containing a polymer and the matting agent to form a film, and a method for applying a dispersion liquid of the matting agent to the formed film. Among those methods, a method of casting the solution containing the polymer and the matting agent to form the film is preferable from the viewpoint of the cost.

In the case of the method of casting the solution containing the polymer and the matting agent to form the film, the matting agent may be dispersed in the polymer solution when the polymer solution is prepared, or the dispersion liquid of the matting agent may be added to the polymer solution right before the polymer solution is cast. When the matting agent is dispersed into the polymer solution, a small amount of a surface active agent or a polymer may be added to the polymer solution as a dispersing agent. Alternatively, a layer of the matting agent may be applied onto the polymer film after the film has been formed, as another method than the above-described methods. In this case, a binder is preferably used when the layer of the matting agent is formed. The binder of the layer containing the matting agent, which can be used in the present invention, is not limited in particular, and may be an oleophilic binder or a hydrophilic binder. A usable oleophilic binder includes a well-known thermoplastic resin, thermosetting resin, radiation curing resin and reactive resin, and a mixture thereof. The above-described resin has the Tg of preferably 80° C. to 400° C., and more preferably of 120° C. to 350° C. The above-described resin has an average molecular weight preferably of 10,000 to 1,000,000 and more preferably of 10,000 to 500,000.

The above-described thermoplastic resin includes: a vinyl-based copolymer such as a vinyl chloride-vinyl acetate copolymer, a copolymer of vinyl chloride and vinyl acetate with vinyl alcohol, maleic acid and/or acrylic acid, a vinyl chloride-vinylidene chloride copolymer, a vinyl chloride-acrylonitrile copolymer and an ethylene-vinyl acetate copolymer; a cellulose derivative such as nitrocellulose, cellulose-acetate-propionate and cellulose-acetate-butylate resins; a rubber-based resin such as a cyclic polyolefin resin, an acrylic resin, a polyvinyl acetal resin, a polyvinyl butyral resin, a polyester polyurethane resin, polyether polyurethane, a polycarbonate polyurethane resin, a polyester resin, a polyether resin, a polyamide resin, an amino resin, a styrene butadiene resin and a butadiene acrylonitrile resin; a silicon-based resin; and a fluorine-based resin.

A dispersion method is not limited in particular, and a conventional method can be used. For instance, a medium disperser includes an attritor, a ball mill, a sand mill and a dynomill. A medium-free disperser includes an ultrasonic wave type, a centrifugal type and a high-pressure type. The above-described dispersion device is preferably used for dispersing the matting agent, but may not be used.

When the matting agent is incorporated into the cycloolefin resin film by being applied onto the cycloolefin resin film, a conventionally well-known application method [for instance, die coater (extrusion coater and slide coater), a roll coater (positive roll coater, inversion roll coater and gravure coater), a rod coater, a blade coater and the like] can be preferably used. In order to apply the matting agent to the film which is a support for the application at such a temperature as not to deform the film and deteriorate the application liquid, the application liquid is applied preferably in a range of 10° C. to 100° C. and more preferably of 20° C. to 80° C. In addition, though the application speed is appropriately adjusted and determined according to the viscosity of the application liquid and the application temperature, the application speed is preferably in a range of 10 m/min to 100 m/min and further preferably of 20 m/min to 80 m/min.

The application layer containing the above-described matting agent can be formed by applying an application liquid having the matting agent dissolved in an appropriate organic solvent, onto a support or a support having another layer given on the back layer, and by drying the application liquid. The matting agent can also be added into the application liquid in the form of a dispersed substance. Solvents to be preferably used include: water; alcohols (methanol, ethanol, isopropanol and the like); ketones (acetone, methyl ethyl ketone, cyclohexanone and the like); esters (esters of acetic acid, formic acid, oxalic acid, maleic acid and succinic acid with methyl, ethyl, propyl and butyl groups, and the like); aromatic hydrocarbons (benzene, toluene, xylene and the like); and amides (dimethylformamide, dimethylacetamide, n-methylpyrrolidone and the like).

A binder having a film-forming capability can be also used when the matting agent is applied. Such a polymer as to be used for the above purpose includes a well-known thermoplastic resin, thermosetting resin, radiation curable resin and reactive resin, a mixture thereof and a hydrophilic binder such as gelatin.

In both of the above-described method for casting the solution containing the polymer and the matting agent to form a film and the method for applying a dispersion liquid of the matting agent to a formed film, the average particle size of the particulates of the matting agent contained in the cycloolefin resin film to be produced can be controlled by changing conventionally well-known dispersion conditions such as the average primary particle size of the particulates of the matting agent in the case of the agglutinative matting agent, the amount of the particulates of the matting agent to be added, the type of the dispersing solvent, the amount of the dispersing solvent to be added, a dispersion method, the type of the dispersing machine, the size of the dispersing machine, the dispersion period of time, energy per unit time given to the dispersion liquid by the dispersing machine, a mixing method, the type of the binder, the amount of the binder to be added, the order of the addition and the amount of the dispersion liquid to be charged.

Even when using the non-agglutinative matting agent, it is preferable to prevent unexpected aggregation by controlling dispersion conditions.

(Peeling Promoter)

Many additives having a remarkable effect of reducing the peeling resistance of the cyclic polyolefin film are found in surface active agents. A preferable and effective peeling agent includes a phosphate ester-based surface active agent, a carboxylic acid-based or carboxylate-based surface active agent, a sulfonic acid-based or sulfonate-based surface active agent and a sulfate ester-based surface active agent. In addition, a fluorine-based surface active agent in which a fluorine atom substitutes for one part of the hydrogen atom bonded to a hydrocarbon chain of the above-described surface active agent is also effective. The peeling agent will be illustrated below.

### RZ-1 C₈H₁₇O—P(═O)—(OH)₂

### RZ-2 C₁₂H₂₅O—P(═O)—(OK)₂

### RZ-3 C₁₂H₂₅OCH₂CH₂O—P(═O)—(OK)₂

### RZ-4 C₁₅H₃₁(OCH₂CH₂)₅O—P(═O)—(OK)₂

### RZ-5 {C₁₂H₂₅O(CH₂CH₂O)₅}₂—P(═O)—OH

### RZ-6 {C₁₈H₃₅(OCH₂CH₂)₈O}₂—P(═O)—ONH₄

RZ-7 (t-C₄H₉)₃—C₆H₂—OCH₂CH₂O—P(═O)—(OK)₂
RZ-8 (iso-C₉H₁₉—C₆H₄—O—(CH₂CH₂O)₅—P(═O)—(OK)(OH)

### RZ-9 C₁₂H₂₅SO₃Na

### RZ-10 C₁₂H₂₅OSO₃Na

### RZ-11 C₁₇H₃₃COOH

### RZ-12 C₁₇H₃₃COOH.N(CH₂CH₂OH)₃

RZ-13 iso-C₈H₁₇—C₆H₄—O—(CH₂CH₂O)₃—(CH₂)₂SO₃Na
RZ-14 (iso-C₉H₁₉)₂—C₆H₃—O—(CH₂CH₂O)₃—(CH₂)₄SO₃Na
RZ-15 Sodium triisopropyl naphthalenesulfonate
RZ-16 Sodium tri-t-butyl naphthalenesulfonate

### RZ-17 C₁₇H₃₃CON(CH₃)CH₂CH₂SO₃Na

### RZ-18 C₁₂H₂₅—C₆H₄SO₃.NH₄

The amount of the peeling agent to be added is preferably in a range of 0.05 to 5 mass % with respect to the cyclic polyolefin, more preferably is in a range of 0.1 to 2 mass %, and most preferably is in a range of 0.1 to 0.5 mass %.

(Retardation-Developing Agent)

In the present invention, a compound having at least two aromatic rings can be used for a retardation-developing agent so that the film develops a retardation value. When the retardation-developing agent is used, the content is preferably in a range of 0.05 to 20 parts by mass with respect to 100 parts by mass of the polymer, more preferably is in a range of 0.1 to 10 parts by mass, further preferably is in a range of 0.2 to 5 parts by mass, and most preferably is in a range of 0.5 to 2 parts by mass. Two or more retardation-developing agents may be concomitantly used.

The retardation-developing agent shows the maximum absorption preferably in a wavelength region of 250 to 400 nm, and preferably does not substantially absorb a light of a visible region.

In the present specification, an “aromatic ring” includes an aromatic heterocycle in addition to an aromatic hydrocarbon ring.

The aromatic hydrocarbon ring is particularly preferably a six-membered ring (in other words, benzene ring).

The aromatic heterocycle is generally an unsaturated heterocycle. The aromatic heterocycle is preferably a five-membered ring, a six-membered ring or a seven-membered ring, and more preferably is the five-membered ring or the six-membered ring. The aromatic heterocycle generally has the largest number of double bonds. The hetero atom is preferably a nitrogen atom, an oxygen atom and a sulfur atom, and particularly preferably is a nitrogen atom. Examples of the aromatic heterocycle include a furan ring, a thiophene ring, a pyrrole ring, an oxazole ring, an isoxazole ring, a thiazole ring, an isothiazole ring, an imidazole ring, a pyrazole ring, a furazan ring, a triazole ring, a pyran ring, a pyridine ring, a pyridazine ring, a pyrimidine ring, a pyrazine ring and a 1,3,5-triazine ring.

Aromatic rings to be preferably used include a benzene ring, a furan ring, a thiophene ring, a pyrrole ring, an oxazole ring, a thiazole ring, an imidazole ring, a triazole ring, a pyridine ring, a pyrimidine ring, a pyrazine ring and a 1,3,5-triazine ring, and a particularly preferable ring is the 1,3,5-triazine ring. Specifically, for instance, a compound described in Japanese Patent Application Laid-Open No. 2001-166144 is preferably used.

The number of the aromatic rings contained in the retardation-developing agent is preferably 2 to 20, more preferably is 2 to 12, further preferably is 2 to 8, and most preferably is 2 to 6.

The bonding relationship between two aromatic rings is classified into three cases where (a) two aromatic rings form a condensed ring; (b) two aromatic rings are directly bonded through a single bond; and (c) two aromatic rings are bonded through a connecting group (a spiro bond cannot be formed because aromatic rings are bonded). The bonding relationship may be any of (a) to (c).

Examples of the condensation ring (a) (condensation ring formed of two or more aromatic rings) include preferably an indene ring, a naphthalene ring, an azulene ring, a fluorene ring, a phenanthrene ring, an anthracene ring, an acenaphthylene ring, a biphenylene ring, a naphthacene ring, a pyrene ring, an indole ring, an isoindole ring, a benzofuran ring, a benzothiophene ring, an indolizine ring, a benzooxazole ring, a benzothiazole ring, a benzimidazole ring, a benzotriazol ring, a purine ring, an indazole ring, a chromene ring, a quinoline ring, an isoquinoline ring, a quinolidine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxathiin ring, a phenoxazine ring and a thianthrene ring. A naphthalene ring, an azulene ring, an indole ring, a benzooxazole ring, a benzothiazole ring, a benzimidazole ring, a benzotriazol ring and a quinoline ring are preferable.

A single bond in (b) is preferably a bond between respective carbon atoms in two aromatic rings. An aliphatic ring or a non-aromatic heterocycle may be formed in between two aromatic rings, by bonding two aromatic rings with two or more single bonds.

The connecting group in (c) is preferably bonded to respective carbon atoms in two aromatic rings. The connecting groups preferably include an alkylene group, an alkenylene group, an alkynylene group, —CO—, —O—, —NH—, —S—, and a combination thereof. Examples of the connecting groups formed of the combination are described below. The relationship of the left and the right in the following examples of the connecting groups may be reversed.

c1: —CO—O—
c2: —CO—NH—
c3: -Alkylene-O—
c4: —NH—CO—NH—
c5: —NH—CO—O—
c6: —O—CO—O—
c7: —O-Alkylene-β
c8: —CO-Alkenylene-
c9: —CO-Alkenylene-NH—
c10: —CO-Alkenylene-O—
c11: -Alkylene-CO—O-Alkylene-O—CO-Alkylene-
c12: —O-Alkylene-CO—O-Alkylene-O—CO-Alkylene-O—
c13: —O—CO-Alkylene-CO—O—
c14: —NH—CO-Alkenylene-
c15: —O—CO-Alkenylene-

The aromatic ring and the connecting group may have a substituent.

Examples of the substituent include a halogen atom (F, Cl, Br and I), hydroxyl, carboxyl, cyano, amino, nitro, sulfo, carbamoyl, sulfamoyl, ureido, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkyl sulfonyl group, an aliphatic amide group, an aliphatic sulfonamide group, an aliphatic substituted amino group, an aliphatic substituted carbamoyl group, an aliphatic substituted sulfamoyl group, an aliphatic substituted ureido group and a non-aromatic heterocyclic group.

The number of carbon atoms (carbon number) of the alkyl group is preferably 1 to 8. A chain alkyl group is preferable to a cyclic alkyl group, and a particularly preferable alkyl group is a straight-chain alkyl group. The alkyl group may further have a substituent (hydroxy, carboxy, an alkoxy group and an alkyl-substituted amino group, for instance). Examples of the alkyl group (including a substituted alkyl group) include methyl, ethyl, n-butyl, n-hexyl, 2-hydroxyethyl, 4-carboxybutyl, 2-methoxy ethyl and 2-diethyl aminoethyl.

The number of carbon atoms of the alkenyl group is preferably 2 to 8. A chain alkenyl group is preferable to a cyclic alkenyl group, and a particularly preferable alkenyl group is a straight-chain alkenyl group. The alkenyl group may further have a substituent. Examples of the alkenyl group include vinyl, allyl and 1-hexenyl.

The number of the carbon atoms of the alkynyl group is preferably 2 to 8. A chain alkynyl group is preferable to a cyclic alkynyl group, and a particularly preferable alkynyl group is a straight-chain alkynyl group. The alkynyl group may further have a substituent. Examples of the alkynyl group include ethynyl, 1-butynyl and 1-hexynyl.

The number of carbon atoms of the aliphatic acyl group is preferably 1 to 10. Examples of the aliphatic acyl group include acetyl, propanoyl and butanoyl.

The number of carbon atoms of the aliphatic acyloxy group is preferably 1 to 10. Examples of the aliphatic acyloxy group include acetoxy.

The number of carbon atoms of the alkoxy group is preferably 1 to 8. The alkoxy group may further have a substituent (an alkoxy group, for instance). Examples of the alkoxy group (including a substituted alkoxy group) include methoxy, ethoxy, butoxy and methoxyethoxy.

The number of carbon atoms of the alkoxycarbonyl group is preferably 2 to 10. Examples of the alkoxycarbonyl group include methoxycarbonyl and ethoxycarbonyl.

The number of carbon atoms of the alkoxycarbonylamino group is preferably 2 to 10. Examples of the alkoxycarbonylamino group include methoxycarbonylamino and ethoxycarbonylamino.

The number of carbon atoms of the alkylthio group is preferably 1 to 12. Examples of the alkylthio group include methylthio, ethylthio and octylthio.

The number of carbon atoms of the alkyl sulfonyl group is preferably 1 to 8. Examples of the alkyl sulfonyl group include methanesulfonyl and ethanesulfonyl.

The number of carbon atoms of the aliphatic amide group is preferably 1 to 10. Examples of the aliphatic amide group include acetamide.

The number of carbon atoms of the aliphatic sulfonamide group is preferably 1 to 8. Examples of the aliphatic sulfonamide group include methane sulfonamide, butane sulfonamide and n-octane sulfonamide.

The number of carbon atoms of the aliphatic substituted amino group is preferably 1 to 10. Examples of the aliphatic substituted amino group include dimethylamino, diethylamino and 2-carboxy ethylamino.

The number of carbon atoms of the aliphatic substituted carbamoyl group is preferably 2 to 10. Examples of the aliphatic substituted carbamoyl group include methylcarbamoyl and diethylcarbamoyl.

The number of carbon atoms of the aliphatic substituted sulfamoyl group is preferably 1 to 8. Examples of the aliphatic substituted sulfamoyl group include methyl sulfamoyl and diethyl sulfamoyl.

The number of carbon atoms of the aliphatic substituted ureido group is preferably 2 to 10. Examples of the aliphatic substituted ureido group include methyl ureido.

Examples of a non-aromatic heterocyclic group include piperidino and morpholino.

The molecular weight of a retardation-developing agent is preferably 300 to 800.

In the present invention, a rod-like compound having a linear molecular structure other than a compound using the 1,3,5-triazine ring can be preferably used. The linear molecular structure means that the molecular structure of the rod-like compound is linear in the most thermodynamically stable structure. The most thermodynamically stable structure can be obtained by analyzing a crystal structure or calculating a molecule orbit. For instance, such a molecule structure as to minimize the heat of formation of the compound can be obtained by calculating the molecular orbit with the use of a molecular orbit calculation software (WinMOPAC2000, a product made by FUJITSU LIMITED for instance). The linear molecular structure means that an angle formed by a main chain in a molecular structure is 140° or more in the most thermodynamically stable structure which is obtained by the calculation as described above.

A rod-like compound having at least two aromatic rings preferably includes compounds expressed by the following general formula (VI).

Ar1-L1-Ar2 General formula (VI)

In the above-described general formula (VI), Ar1 and Ar2 each independently represent an aromatic group.

In the present specification, an aromatic group includes an aryl group (aromatic hydrocarbon group), a substituted aryl group, an aromatic heterocycle group and a substituted aromatic heterocycle group.

The aryl group and the substituted aryl group are preferable to the aromatic heterocycle group and the substituted aromatic heterocycle group. The heterocycle in the aromatic heterocycle group is generally unsaturated. The aromatic heterocycle is preferably a five-membered ring, a six-membered ring or a seven-membered ring, and further preferably is the five-membered ring or the six-membered ring. The aromatic heterocycle generally has the largest number of double bonds. The hetero atom is preferably a nitrogen atom, an oxygen atom or a sulfur atom, and further preferably is the nitrogen atom or the sulfur atom.

Preferable aromatic rings of the aromatic group include a benzene ring, a furan ring, a thiophene ring, a pyrrole ring, an oxazole ring, a thiazole ring, an imidazole ring, a triazole ring, a pyridine ring, a pyrimidine ring and a pyrazine ring, and the benzene ring is particularly preferable.

In the general formula (VI), L1 represents a bivalent connecting group selected from the group consisting of an alkylene group, an alkenylene group, an alkynylene group, —O—, —CO— and a combination thereof.

The alkylene group may have a cyclic structure. The cyclic alkylene group is preferably cyclohexylene, and particularly preferably is 1,4-cycloxylene. A straight-chain alkylene group is preferable to an alkylene group having a branch as the chain alkylene group.

The number of carbon atoms of the alkylene group is preferably 1 to 20, more preferably is 1 to 15, further preferably is 1 to 10, further preferably is 1 to 8, and most preferably is 1 to 6.

The alkenylene group and the alkynylene group have a chain structure preferably to a cyclic structure, and further more preferably have a straight-chain structure than a chain structure having a branch.

The numbers of carbon atoms of the alkenylene group and the alkynylene group are preferably 2 to 10, more preferably are 2 to 8, further preferably are 2 to 6, still further preferably are 2 to 4, and most preferably are 2 (vinylene or ethynylene).

The arylene group has the number of carbon atoms preferably of 6 to 20, more preferably of 6 to 16, and most preferably of 6 to 12.

In the molecular structure expressed by the general formula (VI), an angle formed by Ar1 and Ar2 which sandwich L1 is preferably 140° or larger.

The rod-like compound is further preferably a compound expressed by the following general formula (VII).

Ar1-L2-X-L3-Ar2 General formula (VII)

In the above-described general formula (VII), Ar1 and Ar2 each independently represent an aromatic group. The definition and the examples of the aromatic group are the same as those of Ar1 and Ar2 in the general formula (VI).

In a general formula (VII), L2 and L3 each independently represent a bivalent connecting group selected from the group consisting of an alkylene group, —O—, —CO— and a combination thereof.

The alkylene group has more preferably a chain structure than a cyclic structure, and further more preferably has a straight-chain structure than a chain structure having a branch.

The number of carbon atoms of the alkylene group is preferably 1 to 10, more preferably is 1 to 8, further preferably is 1 to 6, still further preferably is 1 to 4, and most preferably is 1 or 2 (methylene or ethylene).

L2 and L3 are particularly preferably —O—CO— or —CO—O—.

In the general formula (VII), X represents 1,4-cyclohexylene, vinylene or ethynylene.

Two or more rod-like compounds having the maximum absorption wavelength (λmax) of 250 nm or shorter in an ultraviolet-rays absorption spectrum of the solution may be concomitantly used.

The amount of the retardation-developing agent to be added is preferably 0.1 to 30 mass % of the amount of a cyclic polyolefin resin, and more preferably is 0.5 to 20 mass % thereof.

<<Film Formation>>

(1) Pelletization

The above-described thermoplastic resin and the additive are preferably mixed and pelletized before the film is formed by melting.

The thermoplastic resin and the additive are preferably dried before being pelletized, but when a vent-type extruder is used, the vent-type extruder can also dry those simultaneously in place of the drying step. When the thermoplastic resin and the additive are dried with the above-described drying method, a method of heating those in a heating furnace at 90° C. for 8 hours or longer can be employed, but the method is not limited to this. The pellet can be produced by melting the thermoplastic resin and the additive at 150° C. to 280° C., then extruding the melt into the form of a noodle with the use of a twin screw kneading extruder, solidifying the extrudate in water, and cutting the solid. Alternatively, the pellet may be produced with an underwater cutting method of melting the thermoplastic resin and the additive in the extruder, then extruding the melt into water through the mouth ring and directly cutting the extruding substance there at the same time.

Usable extruders include an arbitrary well-known single axis screw extruder, a non-engagement type different direction rotation twin screw extruder, an engagement type different direction rotation twin screw extruder, and an engagement type same direction rotation twin screw extruder, as long as the extruder can melt and knead the mixture.

The pellet preferably has a size of 1 mm² to 300 mm² by the cross-section area and 1 mm to 30 mm by the length, and more preferably has a size of 2 mm² to 100 mm² by the cross-section area and 1.5 mm to 10 mm by the length.

The above-described additive can be charged into the extruder from a raw-material charging port or a vent port provided in the middle of the extruder, when the pellet is produced.

The number of revolutions of the extruder is preferably 10 rpm to 1,000 rpm, more preferably is 20 rpm to 700 rpm, and further preferably is 30 rpm to 500 rpm. When the rotation speed is smaller than the value, the staying period of time becomes longer, the molecular weight decreases due to thermal degradation, and a yellow tinge tends to increase, which are not preferable. In addition, when the rotation speed is excessively large, such problems tend to occur that the molecule is easily cut by shearing to reduce the molecular weight and cross-linked gels are more produced.

The extrusion staying time in the pelletization operation is preferably 10 seconds or longer and 30 minutes or shorter, more preferably is 15 seconds to 10 minutes, and further preferably is 30 seconds to 3 minutes. As long as the thermoplastic resin and the additive can be sufficiently melted, the staying time is preferably short in the point of preventing the resin from degrading and yellowness from occurring.

(2) Drying

The moisture in the pellet is preferably reduced before the film is formed by melting. As for the drying method, the pellet is often dried with the use of a dehumidification drying device, but the method is not limited in particular as long as an aiming moisture content can be obtained. (It is preferable to efficiently dry the pellet by using heating, blowing, decompressing and stirring devices and the like solely or in the combination thereof, and it is further preferable to make a drying hopper have a heat insulation structure.) The drying temperature is preferably 0 to 200° C., more preferably is 40 to 180° C., and particularly preferably is 60 to 150° C. When the drying temperature is excessively low, it not only takes time to dry the pellet, but also the water content does not reach the target value or lower, which are not preferable. On the other hand, when the drying temperature is excessively high, the resin becomes sticky and causes blocking, which are not preferable. The drying air quantity is preferably 20 to 400 m³/time, further preferably is 50 to 300 m³/time, and particularly preferably is 100 to 250 m³/time. When the drying air quantity is small, the drying efficiency is poor, which is not preferable. On the other hand, even when the air quantity is large, the drying effect is little enhanced as long as the air quantity is a certain amount or larger, which is not economical. The dew point of air is preferably 0 to −60° C., further preferably is −10 to −50° C., and particularly preferably is −20 to −40° C. The drying period of time needs to be at least 15 minutes or longer, further preferably is 1 hour or longer, and particularly preferably is 2 hours or longer. On the other hand, even when the drying period of time exceeds 50 hours, an effect for reducing the moisture content is not enough. Accordingly, it is not preferable to unnecessarily extend the drying period of time because the resin may cause the thermal degradation. The thermoplastic resin according to the present invention preferably has a moisture content in an amount of 1.0 mass % or less, further preferably of 0.1 mass % or less, and particularly preferably of 0.01 mass % or less.

(3) Melt Extrusion

The above-described cycloolefin resin is supplied to the inner part of a cylinder through a supply port of the extruder. The inner part of the cylinder comprises sequentially from a supply port side: a supply section (region shown by A) for quantitatively transporting the thermoplastic resin which has been supplied from the supply port; a compression section (region shown by B) for melting, kneading and compressing the thermoplastic resin; and a metering section (region shown by C) for weighing the melted, kneaded and compressed thermoplastic resin. The resin is preferably dried so as to reduce the moisture content with the above-described method. However, in order to prevent the melted resin from being oxidized by remaining oxygen, it is more preferable to extrude the resin by using an extruder in which a current of an inert gas (nitrogen or the like) passes through the inside, or an extruder provided with a vent, which is evacuated. The screw compression ratio of the extruder is set at 2.5 to 4.5, and L/D is set at 20 to 70. Here, the screw compression ratio is expressed by a volume ratio of a supply section A to a metering section C, in other words, by a volume of the supply section A per unit length divided by a volume of the metering section C per unit length, and is calculated by using an outer diameter d1 of the screw shaft in the supply section A, an outer diameter d2 of the screw shaft in the metering section C, a diameter a1 of the groove part of the supply section A and a diameter a2 of the groove part of the metering section C. In addition, the L/D is a ratio of a length of the cylinder to an inner diameter of the cylinder. In addition, the extrusion temperature is set at 200 to 300° C. The temperature in the extruder may be the same temperature at all positions, or have temperature distribution. The temperature in the supply section is more preferably set at a higher temperature than that in the compression section.

When the screw compression ratio is below 2.5 and is excessively small, the resin is not sufficiently melted and kneaded to produce an undissolved portion, the undissolved foreign matter tends to easily remain in the produced thermoplastic film, and further, air bubbles tend to be easily mixed. Thereby, the strength of the thermoplastic film decreases, or the film tends to be easily ruptured when the film is stretched, and the orientation cannot be sufficiently enhanced. On the contrary, when the screw compression ratio exceeds 4.5 and is excessively large, the shear stress is excessively applied to the resin, the resin tends to be easily degraded due to heat generation, and the produced thermoplastic film tends to easily show a yellow tinge. In addition, when the shear stress is excessively applied to the resin, the molecule is cut, the molecular weight decreases, and the mechanical strength of the film decreases. Accordingly, in order to make the produced thermoplastic film show very little yellow tinge, have strong film strength, and further hardly be ruptured by stretching, the screw compression ratio is preferably in a range of 2.5 to 4.5, more preferably is in a range of 2.8 to 4.2, and particularly preferably is in a range of 3.0 to 4.0.

When the L/D is below 20 and is excessively small, the resin is insufficiently melted and kneaded, and tends to easily produce an undissolved foreign matter in the produced thermoplastic film, similarly to the case where the compression ratio is small. On the contrary, when the L/D exceeds 70 and is excessively large, the staying period of time of the thermoplastic resin in the extruder becomes excessively long, which tends to easily cause the degradation of the resin. In addition, when the staying period of time becomes long, the molecules are cut, or the molecular weight decreases to lower the mechanical strength of the thermoplastic film. Accordingly, in order to make the produced thermoplastic film show very little yellow tinge, have the strong film strength, and further hardly be ruptured by stretching, the L/D is preferably in a range of 20 to 70, more preferably is in a range of 22 to 65, and particularly preferably is in a range of 24 to 50.

Thus obtained cycloolefin film has such property values that the haze is 2.0% or less, and a yellow index (YI value) is 10 or less.

As for the type of the extruder, a single axis extruder is generally often employed of which the facility cost is comparatively inexpensive. There are screw types of a full flight, Maddock, Dulmadge and the like in the single axis excluder, but the full flight type is preferable for the cycloolefin resin. It is also possible to use a twin screw extruder which is provided with a vent port in the middle by changing a screw segment though the facility cost is expensive, and which can extrude the melt while releasing an unnecessary volatile component. The twin screw extruders are largely classified into the same direction type and the different direction type, and both of them can be used, but it is preferable to use the same direction rotation type which hardly causes the retained part and shows high self-cleaning performance. By appropriately arranging the vent port, the cycloolefin pellet or powder in an undried state can be directly used. Deckle edges and the like of the film, which have been produced while the film is formed, can be directly reused without being dried.

The preferable diameter of the screw varies according to the amount of the resin to be extruded per target unit time, but preferably is 10 mm to 300 mm, more preferably is 20 mm to 250 mm, and further preferably is 30 mm to 150 mm.

(4) Filtration

In order to filtrate foreign matter in the resin and prevent a gear pump from being damaged due to the foreign matter, it is preferable to filtrate the melt by a so-called breaker plate type which provides a filter medium at the exit of the extruder. At this time, the filtration can be achieved by adjusting the pore diameter in the filter medium and the flow rate of the melted resin, as was described above. In order to further accurately filtrate the foreign matter, it is preferable to provide a filtration apparatus which incorporates a so-called leaf type disk filter therein, in a position after the melt has passed a gear pump. The foreign matter can be filtrated through one filtering portion provided in the extruder, or may be filtrated through a plurality of filtering portions provided in multi-stage. The filtering accuracy of the filter medium is preferably high, but is preferably 15 μmm to 3 μmm and further preferably is 10 μmm to 3 μmm from the point of the withstand pressure of the filter medium and the increase of a filtering pressure due to clogging in the filter medium. Particularly when the leaf type disk filter device is used which filtrates the foreign matter in the last stage, it is preferable to use a filter medium having a high filtering accuracy in the point of the quality. It is possible to adjust the filtering accuracy by adjusting the number of the filter media to be loaded in order to secure the withstand pressure and the suitability of the filter life. As for the type of the filter medium, it is preferable to use a steel material from the viewpoint that the filter medium is used under a high temperature and a high pressure, it is further preferable to use stainless steel, steel or the like among the steel materials, and it is particularly preferable to use stainless steel from the viewpoint of corrosion. As for the constitution of the filter medium, a sintered filter medium can be used which is formed by sintering long fibers of a metal or a metal powder, for instance, other than a filter medium made by plaiting wire rods, and the sintered filter medium is preferable from the viewpoint of the filtering accuracy and the filter life.

(5) Gear Pump

In order to enhance the thickness accuracy, it is important to decrease the fluctuation in the amount of the resin to be charged, and it is effective to provide a gear pump between the extruder and a dice, and to supply a fixed amount of the cellulose acylate resin from the gear pump. The gear pump is a device which accommodates a pair of gears formed of a drive gear and a driven gear therein in a state of making the gears engaged with each other, sucks the resin of a melted state from a sucking port formed in the housing into the inner part of the cavity by driving the drive gear and rotating both of the gears while making the gears engaged with each other, and discharges a fixed amount of the resin from the discharge port similarly formed in the housing. The gear pump absorbs the fluctuation in the discharged amount even when the resin pressure at the end part of the extruder has slightly varied, provides a very small fluctuation in the resin pressure in the downstream side of the film-forming apparatus, and improves the fluctuation in the thickness. The fluctuation amplitude of the resin pressure in the die part can be set at ±1% or less, by using the gear pump.

In order to enhance the quantitative supply performance by the gear pump, it is also possible to employ a method of controlling the pressure at a position prior to the gear pump at a constant value by changing the number of revolutions of the screw. It is also effective to use a high-accuracy gear pump that uses three or more pieces of gears and has solved the fluctuation in the gear of the gear pump.

As for other advantages of using the gear pump, it can be expected to reduce the energy consumption, prevent the temperature rise of the resin, enhance the transportation efficiency, shorten the staying period (detention period) of time of the resin in the extruder, and shorten the L/D of the extruder, because the film can be formed at a reduced pressure of the end part of the screw. In addition, when the filter is used for removing the foreign matter, the amount of the resin to be supplied from the screw occasionally varies along with the increase of the filter pressure when the gear pump is not used, but the problem can be solved by using the gear pump in combination with the filter. On the other hand, use of the gear pump has following disadvantages. Depending on a selecting method of facility, length of the facility becomes long, resulting in a longer detention period of time of the resin. And, it is possible to cut the molecular chain due to the shear stress in the gear pump section. Therefore, cautions are required.

A period of time for the resin to stay in the extruder from a time when the resin enters therein from a supply port till a time when the resin is extruded from the dice is preferably 2 minutes to 60 minutes, more preferably is 3 minutes to 40 minutes, and further preferably is 4 minutes to 30 minutes.

The gear pump needs to be designed (clearance, in particular) so as to match the melt viscosity of the thermoplastic resin, because if the flow of a circulating polymer in the bearing of the gear pump deteriorates, such problems occur that the performance of sealing by the polymer in a drive section and a bearing section also deteriorates, and the fluctuations among metered results and among pressures for delivering and extruding the fluid increase. In addition, the gear pump preferably has a structure in which the fluid stays therein as short as possible, because the staying portion (detention portion) of the gear pump occasionally causes the degradation of the thermoplastic resin. A polymer pipe and an adapter which connect the extruder with the gear pump, or the gear pump with the die and the like also need to be designed so that the fluid stays as short as possible, and preferably so that the fluctuation in the temperature is as small as possible, in order to stabilize the pressure for extruding the thermoplastic resin having a highly temperature dependent melt viscosity. For the purpose of heating the polymer pipe, generally, a band heater of which the facility cost is inexpensive is often used, but it is more preferable to use an aluminum cast heater having less temperature fluctuation. Furthermore, it is preferable to heat the barrel of the extruder with a heater which has been divided into 3 to 20 units and melt the resin, as was described above.

(6) Die

The thermoplastic resin is melted in the extruder which is structured as described above, and the melted resin is continuously sent to the die through the filtration machine and the gear pump, as needed. The die may be any type of a T die, a fishtail die and a hanger coat die which are generally used, as long as the die is designed so that the melted resin stays in the die in a short period. There is no problem in installing a static mixer for increasing the uniformity of the resin temperature just before the T die. The clearance of the outlet part of the T die is generally preferably 1.0 to 5.0 times of the film thickness, more preferably is 1.2 to 3 times, and further preferably is 1.3 to 2 times. When the lip clearance is less than 1.0 time of the film thickness, it is hard to obtain a sheet having a good surface state by film formation. In addition, when the lip clearance is so large as to exceed 5.0 times of the film thickness, the accuracy of the sheet thickness decreases, which is not preferable. The die is a very important facility in determining the accuracy of the film thickness, and accordingly is preferably such a die as to be capable of strictly controlling the adjustment of the thickness. The thickness can be usually adjusted at an interval of 40 to 50 mm, but the die is a type of being capable of adjusting the film thickness preferably at an interval of 35 mm or less and further preferably at an interval of 25 mm or less. In addition, it is important to design the die so that the temperature distribution and the flow rate distribution in the width direction are as little as possible, in order to enhance the uniformity of the formed film. An automatically thickness-adjusting die which measures the thickness of the downstream film, calculates the thickness deviation and feedbacks the result to a thickness-adjusting mechanism is also effective in decreasing the fluctuation in the thickness in a long-period continuous production.

The film is produced generally by using a single-layer film-forming apparatus of which the facility cost is inexpensive, but in some cases, a film having two or more structures can also be produced by providing a functional layer as the outer layer with the use of a multilayer film-forming apparatus. Generally, it is preferable to stack a thin functional layer on the surface layer, but the ratio of layer thicknesses is not limited in particular.

(7) Casting

The film is obtained by extruding the melted resin from the die into the form of a sheet on a casting drum in the above-described condition, and by cooling and solidifying the extruded melt on the casting drum. When the melt-extruded film is heated by the far-infrared heater before the melted resin comes in contact with the casting drum, a leveling effect develops on the drum and the surface becomes approximately uniform, which can reduce the film-thickness distribution and a die streak of the obtained film.

In the present invention, the adhesiveness between the casting drum and the melt-extruded sheet is preferably enhanced by using an electrostatic application method, an air knife method, an air chamber method, a vacuum nozzle method, a touch roll method and the like on the casting drum, but among them, the above-described touch roll method is preferably used.

The touch roll method is a method for placing a touch roll on the casting drum to shape a surface of the film. At this time, the touch roll preferably does not have a high rigidity of a usual level, but preferably has elasticity. However, a touch roll formed of a member (a rubber and the like) which can be elastically deformed and is covered with an extremely thin metal cannot develop a high plane pressure (because the deformation amount of the touch roll is large, the contact area with the casting roll becomes excessively large, and the touch roll cannot develop a sufficient plane pressure), which is not preferable. The wall thickness of the touch roll in the present invention is preferably 0.5 mm or more and 7 mm or less, more preferably is 1.1 to 6 mm, and further preferably is 1.5 to 5 mm. The touch roll and the casting roll have preferably a surface of a mirror plane, of which the arithmetic average height Ra is 100 nm or less, preferably is 50 nm or less, and further preferably is 25 nm or less. The plane pressure of the touch roll is preferably 0.1 MPa or more and 10 MPa or less, more preferably is 0.2 MPa or more and 7 MPa or less, and further preferably is 0.3 MPa or more and 5 MPa or less. The plane pressure to be described here is a value obtained by dividing a force of pressing the touch roll by a contact area of the thermoplastic film and the touch roll.

The touch roll may be a roll which is placed on a metal shaft and passes a heat medium (fluid) between them, or includes a roll in which an elastic body layer is provided between the external cylinder and the metal shaft, and a space between the external cylinder and the elastic body layer is filled with the heat medium (fluid). The temperature of any one of the touch rolls preferably is higher than Tg−10° C. and is Tg+30° C. or lower, more preferably is Tg−7° C. or higher and Tg+20° C. or lower, and further preferably is Tg−5° C. or higher and Tg+10° C. or lower. The temperature of the casting roll is preferably in the same temperature range as the above range.

Usable touch rolls specifically include, for instance, touch rolls described in Japanese Patent Application Laid-Open No. 11-314263, and Japanese Patent Application Laid-Open No. 11-235747.

In addition, it is preferable to use a plurality of casting drums (rolls) and gradually cool the drums. (Among them, the above-described touch roll to be used is arranged so as to touch the first casting roll in the most upstream side (close to the die).) Generally, three cooling rolls are comparatively often used, but the number of the rolls is not limited to that. The diameter of the roll is preferably 50 mm to 5,000 mm, more preferably is 100 mm to 2,000 mm, and further preferably is 150 mm to 1,000 mm. The interval among the plurality of rolls is preferably 0.3 mm to 300 mm by the distance between surfaces, more preferably is 1 mm to 100 mm, and further preferably is 3 mm to 30 mm. In addition, the line speed in the most upstream side of the casting roll is preferably set at 20 m/minute or more and 70 m/minute or less.

(8) Winding

The film is peeled from a casting drum, subsequently is passed through a nip roll, and is wound.

The width of the formed film is 0.7 m to 5 m, further preferably is 1 m to 4 m, and still further preferably is 1.3 m to 3 m. The thickness of thus obtained unstretched film is preferably 20 μm to 250 μm, more preferably is 25 μm to 200 μm, and further preferably is 30 μm to 180 μm.

Both ends of the film are preferably trimmed before being wound. Any type of a rotary cutter, a shear edge and a knife may be used as a trimming cutter. The material also may be any one of carbon steel and stainless steel. Generally, a superhard blade or a ceramic blade is preferably used, because of having the long life and suppressing the production of chips. Portions which have been cut off by a trimming operation may be crushed and used as a raw material again.

It is also preferable to apply a thickness-increasing process (knurling treatment) to one end or both ends. The height of the convexo-convex formed by the thickness-increasing process is preferably 1 μm to 200 μm, more preferably is 10 μm to 150 μm, and further preferably is 20 μm to 100 μm. The thickness-increasing process may form salients on both surfaces or on single surface. The width in the thickness-increasing process is preferably 1 mm to 50 mm, more preferably is 3 mm to 30 mm, and further preferably is 5 mm to 20 mm. The extrusion process can be conducted at room temperature to 300° C.

Thus formed film may be directly stretched (on-line stretching), or may be once wound, then fed and stretched again (off-line stretching).

When the film is wound, it is preferable to attach a lamination film to at least one surface from the viewpoint of preventing a scratch. The thickness of the lamination film is preferably 5 μm to 200 μm, more preferably is 10 μm to 150 μm, and further preferably is 15 μm to 100 μm. The material includes polyethylene, polyester and polypropylene, but is not limited in particular.

The winding tension is preferably 1 kg/m width to 50 kg/width, more preferably is 2 kg/m width to 40 kg/width, and further preferably is 3 kg/m width to 20 kg/width. When the winding tension is less than 1 kg/m width, it is hard to uniformly wind the film. On the contrary, when the winding tension exceeds 50 kg/width, the film is firmly wound, which not only aggravates the wound appearance, but also extends the knurl of the film due to a creep phenomenon and causes an external waviness of the film, or causes a retained double refraction due to the elongation of the film. These phenomena are not preferable. It is preferable to detect the winding tension by tension control on the way of the line, and to wind the film while controlling the winding tension so as to be a constant value. When the film temperatures are different depending on the places of the film-forming line, the length of the film is occasionally slightly different due to the thermal expansion. Accordingly, it is necessary not to apply a tension of a specified value or larger to the film on the way of the line by adjusting a draw ratio between the nip rolls.

It is possible to wind the film with a constant tension by controlling the winding tension through tension control, but it is more preferable to control the winding tension to an appropriate value by providing a taper according to the diameter of the wound coil. Generally, the tension is gradually decreased as the diameter of the wound coil increases, but the tension may be increased as the diameter of the wound coil increases, which is preferable in some cases.

<<Stretching Step>>

A cycloolefin film which has been melted and formed may be transversely stretched or longitudinally stretched, and may be further subjected to relaxation treatment in combination with the above steps. The operation can be conducted, for instance, in combination with the following steps.
1 transverse stretching
2 transverse stretching→relaxation treatment
3 longitudinal stretching→transverse stretching
4 longitudinal stretching→transverse stretching→relaxation treatment
5 longitudinal stretching→relaxation treatment→transverse stretching→relaxation treatment
6 transverse stretching→longitudinal stretching→relaxation treatment
7 transverse stretching→relaxation treatment→longitudinal stretching→relaxation treatment
8 longitudinal stretching→transverse stretching→longitudinal stretching
9 longitudinal stretching→transverse stretching→longitudinal stretching→relaxation treatment
10 longitudinal stretching
11 longitudinal stretching→relaxation treatment Among them, more preferable combinations are 1 to 4 and 10 to 11, and further preferable combinations are 2, 4 and 11. Among them, more preferable combinations are 1 to 4, and further preferable combinations are 2 and 4.

(Longitudinal Stretching)

In the present invention, it is also preferable to stretch the film by the combinations of transverse stretching and longitudinal stretching. In this case, it is more preferable to longitudinally stretch the film and then transversely stretch the film.

The longitudinal stretching process can be achieved by providing two pairs of nip rolls, and controlling a peripheral speed of nip rolls in an outlet side so as to be higher than that of nip rolls in an inlet side, while heating the space between the nip rolls in the both sides. At this time, properties of developing retardation in a thickness direction can be changed by varying a length (L) between the nip rolls and a width (W) of a film before being stretched. Rth can be diminished by controlling L/W (referred to as the aspect ratio) to more than 2 but 50 or less (long span stretching), and can be increased by controlling the aspect ratio to 0.01 or more and 0.3 or less (short span stretching). In the present invention, any method may be used among the long span stretching, the short span stretching and intermediate stretching (in which medium stretching=L/W is more than 0.3 and 2 or less), but the long span stretching or the short span stretching is preferably used because of being capable of making the orientation angle small. Furthermore, it is preferable to employ the stretching method by distinguishing the stretching method in ways of employing the short span stretching when aiming at imparting high Rth, and employing the long span stretching when aiming at imparting low Rth.

(1-1) Long Span Stretching

The film is extended by being stretched, but at this time, the film decreases its thickness and width so as to reduce its volume change. At this time, the shrinkage of the film in the width direction is limited by friction generated between the nip roll and the film. For this reason, when the length between the nip rolls increases, the film is easily shrunk in the width direction and can suppress the reduction of the thickness. When the thickness is largely reduced, the film develops the same effect of having been compressed in the thickness direction, the molecules are orientated in the film surface, and Rth tends to easily increase. On the contrary, when the aspect ratio is large and the thickness is reduced little, Rth hardly develops and a low Rth value can be realized.

Furthermore, when the aspect ratio is long, the uniformity in the width direction can be enhanced. This occurs due to the following reasons.

The film tries to shrink in the width direction by being longitudinally stretched. Both sides of the central part in the width direction also try to shrink in the width direction, and consequently form a state of a tug of war. Accordingly, the central part cannot freely shrink.

On the other hand, at an end in the width direction of the film, a state of the tug of war occurs only in one side. Accordingly, the film in the end can comparatively freely shrink.

The difference in the shrinkage behavior caused by the stretching operation between both ends and the central part leads to the nonuniformity of a stretched amount in the width direction.

Such nonuniformity of the shrinkage behavior between both ends and the central part causes the distribution of retardation in the width direction and the deviation of axes (dispersion of orientated angles of retardance axes). On the other hand, in a long span stretching method, since the film is slowly stretched in the long distance between two nip rolls, nonuniformities are progressively uniformized (molecular orientations are uniformized) during the stretching step. In contrast to this, such a uniformizing action does not occur in a normal longitudinal stretching process (aspect ratio=more than 0.3 and less than 2).

The aspect ratio is preferably more than 2 and 50 or less, more preferably is 3 to 40, and further preferably is 4 to 20. The stretching temperature is preferably (Tg−5° C.) to (Tg+100)° C., more preferably is (Tg) to (Tg+50)° C., and further preferably is (Tg+5) to (Tg+30)° C. The stretch ratio is preferably 1.05 to 3 times, more preferably is 1.05 to 1.7 times, and further preferably is 1.05 to 1.4 times. Such a long span stretching method may also be conducted in multiple stages with three or more pairs of nip rolls, and the longest aspect ratio among the multiple stages may be in the above-described range.

Such a long span stretching method may be conducted by heating and stretching the film existing in between two pairs of nip rolls, which are apart from each other by a predetermined distance. The heating method may be a heater heating method (heating the film with a radiant heat by installing an infrared heater, a halogen heater, a panel heater or the like above or below the film), or a zone-heating method (heating the film in a zone which has been controlled to a predetermined temperature by blowing hot air or the like). In the present invention, the zone-heating method is preferable from the viewpoint of the uniformity of the stretching temperature. At this time, the nip roll may be provided in the stretching zone, or may be provided in the outside of the zone, but is preferably provided in the outside of the zone so as to prevent sticking between the film and the nip roll. It is preferable to preheat the film before such a stretching process. The preheating temperature is Tg−80° C. or higher and Tg+100° C. or lower.

The Re value obtained by such a stretching process is preferably 0 to 200 nm, more preferably is 10 to 200 nm and further preferably is 15 nm to 100 nm, and the Rth value is preferably 30 to 500 nm, more preferably is 50 to 400 nm and further preferably is 70 to 350 nm. By this stretching process, the ratio of Rth to Re (Rth/Re) can be controlled to preferably 0.4 to 0.6, and more preferably to 0.45 to 0.55. The film having such properties can be used as an A-plate type of a phase difference plate. Furthermore, by this stretching process, the dispersion of the Re value and the Rth value can be controlled to 5% or less, more preferably to 4% or less, and further preferably to 3% or less.

The ratio of the film width before and after stretching (film width after stretching/film width before stretching) obtained according to such a stretching process is preferably 0.5 to 0.9, more preferably is 0.6 to 0.85, and further preferably is 0.65 to 0.83.

(1-2) Short Span Stretching

The film is longitudinally stretched (in short span stretching process) by setting the aspect ratio (L/W) preferably at more than 0.01 and less than 0.3, more preferably at 0.03 to 0.25, and further preferably at 0.05 to 0.2. By stretching the film at the aspect ratio (L/W) in such a range, a neck-in (shrinkage in a direction transverse to a stretching direction due to stretch) can be decreased. In order to compensate the extension in the stretching direction, the width and the thickness decrease, but in such a short span stretching process, the shrinkage in a width direction is suppressed and the thickness decreases with precedence. As a result, the film is compressed in the thickness direction, and the orientating action (plane orientation) progresses in the thickness direction. As a result, Rth which is a measure of the anisotropy in the thickness direction tends to easily increase. On the other hand, conventionally, the film has been generally stretched at the aspect ratio (L/W) of approximately 1 (0.7 to 1.5). This is because though the film is stretched normally by placing a heater for heating between the nip rolls, when the L/W is excessively large, the film cannot be uniformly heated with the heater, and easily causes a stretch distribution, and when the L/W is excessively small, the heater is difficult to be placed and cannot sufficiently heat the film.

The above-described short span stretching process can be conducted by changing the transportation speed between two or more pairs of nip rolls, and can be achieved by arranging two pairs of the nip rolls not in a normal roll arrangement (FIG. 1) but in an oblique arrangement (of vertically displacing rotation axes of nip rolls in front and back from each other) (FIG. 2). In such an arrangement, the heater for heating cannot be placed in between the nip rolls. Accordingly, it is preferable to pass a heat medium in the nip roll and heat the film thereby. It is also preferable to provide a preheat roll in which the heat medium is passed in the inner part before a nip roll of the inlet side, and heat the film before the stretching process.

The stretching temperature is preferably (Tg−5° C.) to (Tg+100)° C., more preferably is (Tg) to (Tg+50)° C. and further preferably is (Tg+5) to (Tg+30)° C., and the preheating temperature is preferably Tg−80° C. or higher and Tg+100° C. or lower.

(Transverse Stretching)

The transverse stretching process can be conducted by using a tenter. Specifically, the tenter holds both ends in the width direction of the film with a clip, and expands the film in a transverse direction to stretch the film. At this time, the stretching temperature can be controlled by sending air of a desired temperature to the tenter. The stretching temperature is preferably Tg−10° C. or higher and Tg+60° C. or lower, more preferably is Tg−5° C. or higher and Tg+45° C. or lower, and most preferably is Tg or higher and Tg+30° C. or lower.

By preheating the film before such a stretching process and fixing the heat after the stretching process, the distributions of Re and Rth of the stretched film are reduced, and the dispersion of the orientation angle caused by bowing can be reduced. Either one operation of preheating the film or fixing the heat may be conducted, but both operations are preferably conducted. The operations of preheating the film and fixing the heat are preferably conducted while holding the film with the clip, in other words, are preferably conducted continuously with the stretching operation.

The film is preferably preheated at a temperature higher than the stretching temperature by 1° C. or more and 50° C. or less (by 1° C. to 50° C.), more preferably by 2° C. or more and 40° C. or less (by 2° C. to 40° C.), and further preferably by 3° C. or more and 30° C. or less (by 3° C. to 30° C.). The preheating period of time is preferably 1 second or longer and 10 minutes or shorter, more preferably is 5 seconds or longer and 4 minutes or shorter, and further preferably is 10 seconds or longer and 2 minutes or shorter. When the film is preheated, the width of the tenter is preferably kept approximately constant. Here, “approximately” means a range of ±10% of the width of the unstretched film.

The heat fixation is performed at a temperature lower than the stretching temperature by 1° C. or more and 50° C. or less (by 1° C. to 50° C.), more preferably by 2° C. or more and 40° C. or less (by 2° C. to 40° C.), and further preferably by 3° C. or more and 30° C. or less (by 3° C. to 30° C.). Further preferably, the temperature is controlled to the stretching temperature or lower and also the Tg or lower. The preheating period of time is preferably 1 second or longer and 10 minutes or shorter, more preferably is 5 seconds or longer and 4 minutes or shorter, and further preferably is 10 seconds or longer and 2 minutes or shorter. When the heat is fixed, the width of the tenter is preferably kept approximately constant. Here, “approximately” means a range of 0% of the tenter width after the stretching operation has been finished (same width as that of the tenter after the stretching operation has been finished) to −10% thereof (10% more shrunk than tenter width after the stretching operation has been finished=shrunk width). When the width of the tenter is expanded to the stretching width or wider, a residual strain tends to be generated in the film, and the fluctuation with time of Re and Rth tends to increase, which are not preferable.

Thus, the temperatures preferably satisfy the relation of heat fixation temperature<stretching temperature<preheating temperature.

The reason why the fluctuation in the orientation angle and the Re and Rth can be reduced by preheating the film and fixing the heat is according to the following reasons.

The film is stretched in the width direction, and intends to become thin (neck-in) in a straight direction (longitudinal direction). Because of this, the film before and after the transverse stretching process is stretched, which causes a stress. However, both ends in the width direction of the film are hardly deformed due to the stress because of being fixed with a chuck, but the central part in the width direction is easily deformed due to the stress. As a result, the film is deformed into the form of a bow by the stress due to the neck-in, which causes a bowing phenomenon. Thereby, the distributions of the Re and the Rth and the dispersion of the orientation axes in the plane occur.

In order to suppress the occurrence, the temperature in a side of being preheated (before stretching) is raised, and a temperature in a side of being heat-treated (after stretching) is lowered. Then, the neck-in occurs in a high temperature side (preheated side) having a low modulus of elasticity, and hardly occurs due to heat-treatment (after stretching). As a result, the bowing phenomenon after the stretching process can be suppressed.

By such a stretching operation, the distributions (variations) both in the width direction and in the longitudinal direction of the Re and the Rth can be controlled to 5% or less, more preferably to 4% or less, and further preferably to 3% or less. Furthermore, the orientation angle can be controlled to 90°±5° or less to 0°±5° or less, more preferably to 90°±3° or less or 0°±3° or less, and further preferably to 90°±1° or less or 0°±1° or less.

The process according to the present invention is characterized in that such an effect can be attained even in a high-speed stretching process, and the effect is remarkably shown at a speed of preferably 20 m/minutes or higher, more preferably of 25 m/minutes or higher, and further preferably of 30 m/minutes or higher.

<<Relaxation Treatment>>

The dimension stability can be improved by further conducting relaxation treatment after the stretching process has been finished. The heat relaxation treatment is preferably conducted after either of the longitudinal stretching process and the transverse stretching process or after both of them, and more preferably is conducted after the transverse stretching process. The relaxation treatment may be conducted continuously on line after the stretching process has been finished, or may be conducted off line after the film has been stretched and wound.

The heat relaxation treatment is conducted while the film is transported at Tg−30° C. or higher and Tg+30° C. or lower, more preferably at Tg−30° C. or higher and Tg+20° C. or lower and further preferably at Tg−15° C. or higher and Tg+10° C. or lower; preferably for 1 second or longer and 10 minutes or shorter, more preferably for 5 seconds or longer and 4 minutes or shorter, and further preferably for 10 seconds or longer and 2 minutes or shorter; and preferably at a tension of 0.1 kg/m or more and 20 kg/m or less, more preferably of 1 kg/m or more and 16 kg/m or less, and further preferably of 2 kg/m or more and 12 kg/m or less.

<<Volatile Component During Stretching>>

In the above-described longitudinal stretching process and the transverse stretching process, the volatile component (solvent, moisture and the like) is preferably 1 wt % or less with respect to a resin, more preferably is 0.5 wt % or less, and further preferably is 0.3 wt % or less. Thereby, the deviation of axes occurring during the stretching process can be alleviated. This is because a shrinkage stress due to drying in addition to a shrinkage stress acting in a direction orthogonal to the stretching direction during the stretching process acts in the film, which makes the bowing phenomenon remarkable.

<<Physical Properties after Stretching>>

The Re and the Rth of a thermoplastic film which has been thus longitudinally stretched, transversely stretched or longitudinally and transversely stretched preferably satisfy the following expressions (R-1) and (R-2):

0 nm≦Re≦200 nm; and Expression (R-1)

0 nm≦Rth≦600 nm, Expression (R-2)

wherein Re represents retardation in the plane of the thermoplastic film, and Rth represents retardation in the thickness direction of the thermoplastic film. The Re and the Rth more preferably satisfy:

Rth≧Re×1.1;

180≧Re≧10; and

400≧Rth≧50,

and further preferably satisfy:

Rth≧Re×1.2;

150≧Re≧20; and

300≧Rth≧100.

An angle θ formed by the film-forming direction (longitudinal direction) and a retardance axis of the Re of the film is preferably closer to 0°, +90° or −90°. Specifically, in the case of the longitudinal stretching process, the angle is as preferable as is closer to 0°, preferably to 0°±3°, more preferably to 0°±2°, and further preferably to 0°±1°. In the case of the transverse stretching process, the angle is preferably 90°±3° or −90°±3°, more preferably is 90°±2° or −90°±2°, and further preferably is 90°±1° or −90°±1°.

The distributions of the Re and the Rth are preferably 0% to 8%, more preferably are 0% to 5%, and further preferably are 0% to 3%.

The variations with time of the Re and the Rth when the film has been stored (changes of Re and Rth before and after the film has been left at 80° C. for 500 hours, which will be described later in detail) are preferably 0% or more and 8% or less, more preferably are 0% or more and 6% or less, and further preferably are 0% or more and 4% or less.

The thickness of the thermoplastic film after any of the stretching processes is preferably 15 μm to 200 μm, more preferably is 20 μm to 120 μm, and further preferably is 30 μm to 80 μm. The distribution of the thickness in any of the longitudinal direction and the width direction is preferably 0% to 3%, more preferably is 0% to 2%, and further preferably is 0% to 1%. When a thin film is used, a residual strain further hardly remains in the film and retardation further hardly changes with time, after the film has been stretched. This is because when a thick film is cooled after having been stretched, the inner part is cooled more slowly than the surface, and the residual strain tends to be easily generated due to a difference between the amounts of heat shrinkage.

The rate of dimensional change due to heat is preferably 0% or more and 0.5% or less, more preferably is 0% or more and 0.3% or less, and further preferably is 0% or more and 0.2% or less. The rate of dimensional change due to heat means the change in the dimension occurring when the film has been heat-treated for 5 hours at 80° C.

The number of foreign substances having the maximum diameter of 50 μm or more contained in the film according to the present invention is 0 piece/3 mm length×full width, and the number of the foreign substances having the maximum diameter of 20 to 50 μm is 30 pieces/3 mm length×full width or less. Furthermore, when the film is arranged between two sheets of polarizing plates which are arranged in a cross Nichols state, and is observed from a polarizing plate side while projecting light from another polarizing plate side, the number of a luminescent points out of the foreign substances having the maximum diameter of 20 to 50 μm is preferably 15 pieces/3 mm length×full width or less, more preferably is 10 pieces/3 mm length×full width or less, and further preferably is 5 pieces/cm² or less. The number and the size of the foreign substances can be measured by sampling an area of 3 m length×full width of the formed film and by using an optical microscope.

<<Processing for Cycloolefin Film>>

Thus obtained cycloolefin film according to the present invention may be used solely or in combination with a polarizing plate, and may be used after having provided a liquid crystal layer, a layer having its refractive index controlled (low reflective layer) or a hard coating layer on the film or the plate. The above products can be attained through the following processes.

(Surface Treatment)

Usable surface treatment includes glow discharge treatment, UV irradiation treatment, corona treatment, flame treatment, and acid or alkali treatment. Here, the glow discharge treatment includes a treatment using low-temperature plasma occurring under a low-pressure gas of 10⁻³ to 20 Torr (0.13 to 2,700 Pa). The plasma treatment under the atmospheric pressure is also a preferable glow discharge treatment.

A plasma-excitable gas means a gas which is excited to form plasma on the above-described condition, and includes argon, helium, neon, krypton, xenon, nitrogen, carbon dioxide, fluorocarbons such as tetrafluoromethane, and mixtures thereof. The gases are described in detail on pages 30 to 32 in Journal of Technical Disclosure by the Japan Institute of Invention and Innovation (Technical Disclosure No. 2001 to 1745, published on Mar. 15 in 2001 by the Japan Institute of Invention and Innovation). In the plasma treatment at the atmospheric pressure which attracts attention in recent years, an irradiation energy, for instance, of 20 to 500 KGy is used under 10 to 1,000 Key, and an irradiation energy of 20 to 300 KGy is more preferably used under 30 to 500 Key.

Among them, the glow discharge treatment, the corona treatment and the flame treatment are particularly preferable. It is also preferable to provide an under-coating layer on the film for increasing adhesion with a functional layer. The under-coating layer may be formed after having been subjected to the above-described surface treatment, or may be formed without being subjected to the surface treatment. The detail of the under-coating layer is described on page 32 in Journal of Technical Disclosure by the Japan Institute of Invention and Innovation (Technical Disclosure No. 2001 to 1745, published on Mar. 15 in 2001 by the Japan Institute of Invention and Innovation).

These surface treatment and under-coating processes can be included in the end of the film-forming process, can be conducted solely, or can also be conducted in the step of forming a functional layer, which will be described later.

(Addition of Functional Layer)

The cycloolefin film according to the present invention is preferably combined with a functional layer which is described in detail on pages 32 to 45 in Journal of Technical Disclosure by the Japan Institute of Invention and Innovation (Technical Disclosure No. 2001 to 1745, published on Mar. 15 in 2001 by the Japan Institute of Invention and Innovation). Among them, a polarizing layer (polarizing plate), an optical compensation layer (optical compensation sheet) and an antireflection layer (antireflection film) are preferably imparted to the film.

(A) Addition of Polarizing Layer (Production of Polarizing Plate)

(A-1) Used Material

At present, a commercial polarizing layer is generally produced by immersing a stretched polymer into iodine in a bathtub or a solution of a dichroism pigment to make the iodine or the dichroism pigment permeate a binder. A usable polarizing film includes an application type of polarizing film represented by Optiva Inc. The iodine and the dichroism pigment in the polarizing film develop a polarizing performance by being orientated in the binder. Usable dichroism pigments include azo pigment, stilbene-based pigment, pyrazolone-based pigment, triphenylmethane-based pigment, quinoline-based pigment, oxazine-based pigment, thiazine-based pigment and anthraquinone-based pigment. A preferred dichroism pigment is soluble in water. The dichroism pigment preferably has a hydrophilic substituent (sulfo, amino and hydroxyl, for instance). The dichroism pigment includes, for instance, a compound described on page 58 in Journal of Technical Disclosure by the Japan Institute of Invention and Innovation, Technical Disclosure No. 2001 to 1745 (published on Mar. 15 in 2001).

Usable binders for the polarizing film include any one of a polymer cross-linkable by itself and a polymer to be cross-linked by a crosslinking agent, and a plurality of combinations thereof. The binders include, for instance, a methacrylate-based copolymer, a styrene-based copolymer, polyolefin, polyvinyl alcohol and modified polyvinyl alcohol, poly(N-methylolacrylamide), polyester, polyimide, a vinyl acetate copolymer, carboxymethyl cellulose and polycarbonate, which are described in paragraph [0022] in the specification of Japanese Patent Application Laid-Open No. 8-338913. A silane coupling agent can be used as the polymer. Among them, water-soluble polymers (poly(N-methylolacrylamide), carboxymethyl cellulose, gelatin, polyvinyl alcohol and modified polyvinyl alcohol, for instance) are preferable; gelatin, polyvinyl alcohol and modified polyvinyl alcohol are further preferable; and polyvinyl alcohol and modified polyvinyl alcohol are most preferable. It is particularly preferable to concomitantly use two of polyvinyl alcohols or modified polyvinyl alcohols having different polymerization degrees from each other. The saponification degree of the polyvinyl alcohol is preferably 70 to 100%, and further preferably is 80 to 100%. The polymerization degree of the polyvinyl alcohol is preferably 100 to 5,000. The modified polyvinyl alcohol is described in each of Japanese Patent Application Laid-Open No. 8-338913, Japanese Patent Application Laid-Open No. 9-152509 and Japanese Patent Application Laid-Open No. 9-316127. Two or more of polyvinyl alcohols and modified polyvinyl alcohols may be used concomitantly.

The lower limit of the binder thickness is preferably 10 μm. The thinner is the upper limit of the binder thickness, the better is the film quality from the viewpoint of light leakage in a liquid crystal display device. The upper limit is preferably the thickness of a currently-commercial polarizing plate (approximately 30 μm) or less, more preferably is 25 μm or less, and further preferably is 20 μm or less.

The binder for a polarizing film may be cross-linked. A polymer or a monomer having a cross-linkable functional group may be mixed in the binder, or the cross-linkable functional group may be imparted to the binder polymer itself. The binder can be cross-linked by light, heat or a pH change to form a binder having a cross-linked structure. The crosslinking agent is described in the specification of U.S. Reissued Pat. No. 23297. A boron compound (boric acid and borax, for instance) can also be used as a crosslinking agent. The amount of the crosslinking agent to be added into the binder is preferably 0.1 to 20 mass % with respect to a binder. The amount of the crosslinking agent enhances the orientation properties of a polarizing element and the hygrothermal resistance of the polarizing film.

Even after a crosslinking reaction has been finished, an unreacted crosslinking agent is preferably 1.0 mass % or less, and further preferably is 0.5 mass % or less. Thereby, the weathering resistance is enhanced.

(A-2) Stretching of Polarizing Layer

The polarizing film is preferably stained with iodine or a dichromatic dye after having been stretched (stretching method) or having been rubbed (rubbing method).

In the case of the stretching method, the stretch ratio is preferably 2.5 to 30.0 times, and further preferably is 3.0 to 10.0 times. The polarizing film can be stretched with a dry stretching method in the air. Alternatively, the polarizing film may also be subjected to a wet stretching method in a state of being immersed in water. The stretch ratio in the dry stretching method is preferably 2.5 to 5.0 times, and the stretch ratio in the wet stretching method is preferably 3.0 to 10.0 times. The polarizing film may be stretched in parallel to an MD direction (parallel stretching), and may be stretched in an oblique direction (oblique stretching). These stretching processes may be conducted at one time or at several divided times. By being stretched at divided several times, the polarizing film can be more uniformly stretched even in a high-ratio stretching process.

(a) Parallel Stretching Method

A PVA film is swelled before being stretched. The swelling degree is 1.2 to 2.0 times (ratio of mass after having been swelled to mass before being swelled). After this, the polarizing film is stretched in an aqueous medium bath or a dyeing bath having a dichroism substance dissolved therein at 15 to 50° C. and particularly at 17 to 40° C., while being continuously transported through a guide roll and the like. The PVA film can be stretched by being held by two pairs of nip rolls, of which the transportation speeds are set so that the transportation speed of the nip roll in the subsequent stage is larger than that in a preceding stage. The stretch ratio is based on a ratio of the length of the film after having been stretched to that in the initial state (hereafter the same), but a preferred stretch ratio is 1.2 to 3.5 times, and particularly is 1.5 to 3.0 times, from the viewpoint of the above-described working effect. After this, the stretched film is dried at 50° C. to 90° C. and the polarizing film is obtained.

(b) Oblique Stretching Method

A usable oblique stretching method includes a method of stretching a film with a tenter that projects in an oblique direction, which is described in Japanese Patent Application Laid-Open No. 2002-86554. Because of being stretched in the air in this oblique stretching method, the film needs to contain water before being stretched so as to be easily stretched. The water content is preferably 5% to 100% and more preferably is 10% to 100%.

The temperature in the stretching process is preferably 40° C. to 90° C. and more preferably is 50° C. to 80° C. The humidity is preferably 50% to 100% by relative humidity, more preferably is 70% to 100% by relative humidity, and further preferably is 80% to 100% by relative humidity. The speed of advance in the longitudinal direction is preferably 1 m/minute or more and more preferably is 3 m/minutes or more.

After the stretching process has been finished, the stretched film is dried preferably at 50° C. to 100° C. and more preferably at 60° C. to 90° C. for 0.5 minute to 10 minutes. The drying period of time is more preferably 1 minute to 5 minutes.

The absorption axis of thus obtained polarizing film is preferably 10° to 80°, more preferably is 30° to 60°, and further preferably is substantially 45° (40° to 50°).

(A-3) Lamination

A polarizing plate is produced by laminating a thermoplastic film which has been subjected to the above-described surface treatment with a polarizing layer which has been stretched and adjusted. The lamination direction is controlled so that an angle formed by a direction of a cast axis of the thermoplastic film and a direction of a stretched axis of the polarizing plate preferably becomes 45°.

The adhesive for lamination is not limited in particular, but includes a PVA-based resin (including a modified PVA such as an acetoacetyl group, a sulfonic group, a carboxyl group and an oxyalkylene group) and an aqueous solution of a boron compound. Among them, the PVA-based resin is preferable. The thickness of the adhesive layer formed after having been dried is preferably 0.01 to 10 μm, and particularly preferably is 0.05 to 5 μm.

Thus obtained polarizing plate preferably has high light transmittance (optical transparency) and preferably has high degree of polarization as well. The transmittance of the polarizing plate is preferably in a range of 30 to 50% for a light with a wavelength of 550 nm, more preferably is in a range of 35 to 50%, and most preferably is in a range of 40 to 50%. The degree of polarization is preferably in a range of 90 to 100% for a light with a wavelength of 550 nm, more preferably is in a range of 95 to 100%, and most preferably is in a range of 99 to 100%.

Furthermore, a circular polarized light can be prepared by laminating thus obtained polarizing plate with a plate with λ/4. In this case, the plates are laminated so that an angle formed by the retardance axis of the plate with λ/4 and the absorption axis of the polarizing plate can be 45 degrees. At this time, the plate with λ/4 is not limited in particular, but preferably has such a wavelength dependency as to develop smaller retardation for a light with a shorter wavelength. Furthermore, it is preferable to use a polarizing film which has an absorption axis tilted by 20° to 70° with respect to the longitudinal direction, and the plate with λ/4, which is formed of an optically anisotropic layer made from a liquid crystalline compound.

(B) Addition of Optical Compensation Layer (Production of Optical Compensation Sheet)

The optically anisotropic layer is directed at compensating a liquid crystalline compound in a liquid crystal cell when a liquid crystal display device displays black, and is formed by forming an orientation film on the thermoplastic film according to the present invention and further imparting an optically anisotropic layer thereon.

(B-1) Orientation Film

An orientation film is provided on a thermoplastic film which has been subjected to the above-described surface treatment. This film has a function of specifying a direction of orientating liquid crystalline molecules. However, the orientation film finishes the role, when the liquid crystalline compound has been orientated and the orientated state has been fixed. Accordingly, the orientation film is not necessarily indispensable as a component of the present invention. In other words, the polarizing plate of the present invention can be also produced by transcribing only the optically anisotropic layer on the orientation film of which the orientated state is fixed onto a polarizer.

The orientation film can be formed by means of subjecting an organic compound (preferably polymer) to rubbing treatment, subjecting the inorganic compound to an oblique vapor-deposition process, forming a layer having micro grooves thereon, or accumulating an organic compound (ω-tricosanoic acid, dioctadecyl methyl ammonium chloride or methyl stearate, for instance), with the Langmuir-Blodgett method (LB film). Furthermore, an orientation film is known which forms an orientation function therein by operations of imparting an electric field to an organic compound, imparting a magnetic field to the organic compound or irradiating the organic compound with light.

The orientation film is preferably formed by subjecting the polymer to the rubbing treatment. The polymer to be used for the orientation film has a molecular structure which has a function of orientating liquid crystalline molecules in principle.

In the present invention, it is preferable to bond a side chain having a cross-linkable functional group (double bond, for instance) in addition to a function of orientating the liquid crystalline molecules with a main chain, or introduce a cross-linkable functional group having a function of orientating the liquid crystalline molecules to a side chain.

The polymer to be used for the orientation film can employ any one of a polymer cross-linkable by itself and a polymer which is cross-linked by a crosslinking agent, and a plurality of combinations thereof. Examples of the polymer include, for instance, a methacrylate-based copolymer, a styrene-based copolymer, polyolefin, polyvinyl alcohol and a modified polyvinyl alcohol, poly(N-methylolacrylamide), polyester, polyimide, a vinyl acetate copolymer, carboxymethyl cellulose and polycarbonate, which are described in the paragraph number [0022] in the specification of Japanese Patent Application Laid-Open No. 8-338913. A silane coupling agent can be used as the polymer. Water-soluble polymers (poly(N-methylolacrylamide), carboxymethyl cellulose, gelatin, polyvinyl alcohol and modified polyvinyl alcohol, for instance) are preferable; gelatin, polyvinyl alcohol and modified polyvinyl alcohol are further preferable; and polyvinyl alcohol and modified polyvinyl alcohol are most preferable. It is particularly preferable to concomitantly use two of polyvinyl alcohols or modified polyvinyl alcohols having different polymerization degrees from each other. The saponification degree of the polyvinyl alcohol is preferably 70 to 100%, and further preferably is 80 to 100%. The polymerization degree of the polyvinyl alcohol is preferably 100 to 5,000.

A side chain having a function of orientating liquid crystalline molecules generally has a hydrophobic group as a functional group. The specific type of the functional group is determined according to the type of the liquid crystalline molecule and a required orientation state. For instance, a modification group can be introduced into the modified polyvinyl alcohol by copolymerization modification, chain transfer modification or block polymerization modification. Examples of the modification group include hydrophilic groups (carboxylic group, sulfonic group, phosphonic group, amino group, ammonium group, amido group, thiol group and the like), a hydrocarbon group having a carbon number of 10 to 100, a hydrocarbon group substituted with a fluorine atom, a thioether group, polymerizable groups (unsaturated polymerizable group, epoxy group, aziridinyl group and the like) and alkoxysilyl groups (trialkoxy, dialkoxy, monoalkoxy and the like). Specific examples of these modified polyvinyl alcohol compounds include those, for instance, described in paragraphs [0022] to [0145] in the specification of Japanese Patent Application Laid-Open No. 2000-155216, paragraphs [0018] to [0022] in the specification of Japanese Patent Application Laid-Open No. 2002-62426, and the like.

The polymer for the orientation film can be copolymerized with a polyfunctional monomer contained in an optically anisotropic layer by bonding the side chain having the cross-linkable functional group to the main chain of the polymer of the orientation film or introducing the cross-linkable functional group into the side chain having the function of orientating liquid crystalline molecules. As a result, not only polyfunctional monomers are firmly bonded with each other, but also the polymers for the orientation film are firmly bonded with each other and the polyfunctional monomer and the polymer for the orientation film are firmly bonded with each other by a covalent bond. Therefore, the strength of the optical compensation sheet can be remarkably enhanced by introducing the cross-linkable functional group into the polymer for the orientation film.

The cross-linkable functional group of the polymer for the orientation film preferably contains a polymerizable group similarly to that in the polyfunctional monomer. Specifically, the cross-linkable functional groups include those, for instance, described in paragraphs [0080] to [0100] in the specification of Japanese Patent Application Laid-Open No. 2000-155216. The polymer for the orientation film can be cross-linked by using a crosslinking agent other than the above-described cross-linkable functional group.

The above-described crosslinking agent includes aldehyde, an N-methylol compound, a dioxane derivative, a compound which works by activating a carboxyl group, an activated vinyl compound, an activated halogen compound, isoxazole and dialdehyde starch. Two or more types of crosslinking agents may be concomitantly used. Specifically, the crosslinking agents include, for instance, compounds described in paragraphs [0023] to [0024] in the specification of Japanese Patent Laid-Open No. 2002-62426. A preferred crosslinking agent is aldehyde with high reactive activity, and is particularly glutaraldehyde.

The amount of the crosslinking agent to be added is preferably 0.1 to 20 mass % with respect to the above-described polymer, and further preferably is 0.5 to 15 mass %. The amount of the unreacted crosslinking agent which remains in the orientation film is preferably 1.0 mass % or less, and further preferably is 0.5 mass % or less. Thus produced orientation film shows such a sufficient durability as not to cause reticulation, even when having been used in a liquid crystal display device for a long period of time or having been left in an atmosphere of high temperature and high humidity for a long period of time.

The orientation film can be formed basically by applying a liquid containing the above-described polymer which is a material for forming an orientation film and the crosslinking agent onto a transparent support member, then drying the liquid by heating (crosslinking) the content, and subjecting the dried film to rubbing treatment. The crosslinking reaction may be conducted at an arbitrary time after the liquid has been applied onto the transparent support member, as is described above. When a water-soluble polymer such as polyvinyl alcohol is used as the material for forming the orientation film, an application liquid is preferably a mixture solvent of an organic solvent showing a defoaming action (methanol, for instance) and water. The ratio of water:methanol by mass ratio is preferably 0:100 to 99:1, and further preferably is 0:100 to 91:9. Thereby, the generation of bubbles can be suppressed, and defects in the orientation film and further on the surface of the optically anisotropic layer are remarkably reduced.

A preferred application method for the orientation film is a spin coating method, a dip coating method, a curtain coating method, an extrusion coating method, a rod coating method or a roll coating method. A particularly preferred application method is the rod coating method. The film after having been dried has preferably the thickness of 0.1 to 10 μm. The film can be dried by being heated at 20° C. to 110° C. In order to form sufficient crosslink, the drying temperature is preferably 60° C. to 100° C. and particularly preferably is 80° C. to 100° C. The drying period of time can be 1 minute to 36 hours but preferably is 1 minute to 30 minutes. The pH is also preferably set at the optimal value for the crosslinking agent to be used. When glutaraldehyde is used, the pH is preferably 4.5 to 5.5 and particularly preferably is 5.

The orientation film is provided on the transparent support member or the above-described under-coating layer. The orientation film can be formed by crosslinking a polymer layer as was described above and subjecting the surface of the film to the rubbing treatment.

A treatment method which is widely adopted as a treatment process for orientating liquid crystals in an LCD can be applied to the above-described rubbing treatment. Specifically, the method can be used which orientates molecules by rubbing the surface of the orientation film in a certain direction with the use of paper, gauze, felt, rubber, nylon, polyester fiber or the like. The method can be conducted generally by rubbing the surface several times with the use of a cloth which has fibers with uniform length and thickness uniformly transplanted thereon, or the like.

When being industrially conducted, the rubbing treatment is performed by bringing a rotating rubbing roll in contact with the film which is provided with a polarizing layer and is being transported. The rubbing roll is preferably controlled so that all of the circularity, the cylindricity and the deviation (eccentricity) are 30 μm or less. The lap angle of the film with the rubbing roll is preferably 0.1° to 90°. However, by winding the film around the rubbing roll at 360° or more, stable rubbing treatment can be attained as is described in Japanese Patent Application Laid-Open No. 8-160430. The transportation speed of the film is preferably 1 to 100 m/min. The rubbing angle is preferably selected appropriately from a range of 0° to 60°. When the orientation film is used for a liquid crystal display device, the rubbing angle is preferably 40° to 50° and particularly preferably is 45°. The film thickness of thus obtained orientation film is preferably in a range of 0.1 to 10 μm.

Next, the liquid crystalline molecule of the optically anisotropic layer on the orientation film is orientated. Afterward, the polymer for the orientation film is cross-linked, as needed, by making the polymer for the orientation film react with a polyfunctional monomer contained in the optically anisotropic layer, or by using a crosslinking agent.

The liquid crystalline molecule which is used for the optically anisotropic layer includes a rod-like liquid crystalline molecule and a disc-like liquid crystalline molecule. The rod-like liquid crystalline molecule and the disc-like liquid crystalline molecule may be a high-molecular liquid crystal or a low-molecular liquid crystal, and further includes a liquid crystal which does not show liquid crystallinity after the low-molecular liquid crystal has been cross-linked.

(B-2) Rod-Like Liquid Crystalline Molecule

Rod-like liquid crystalline molecules to be preferably used are azomethines, azoxies, cyanobiphenyls, cyanophenyl esters, benzoic esters, cyclohexane carboxylic phenylesters, cyanophenyl cyclohexanes, cyano-substituted phenylpyrimidines, alkoxy-substituted phenylpyrimidines, phenyldioxanes, tolans and alkenylcyclohexyl benzonitriles.

The rod-like liquid crystalline molecule also includes a metal complex. A liquid crystal polymer which contains the rod-like liquid crystalline molecule in a repeated unit can be also used as the rod-like liquid crystalline molecule. In other words, the rod-like liquid crystalline molecule may be bonded with a (liquid crystal) polymer.

The rod-like liquid crystalline molecules is described in Chapters 4, 7 and 11 in Quarterly magazine The Elements of Chemistry vol. 22 (1994), The Chemistry of Liquid Crystals edited by The Chemical Society of Japan, and in Chapter 3 of liquid crystal device handbook edited by 142nd Committee of Japan Society for the Promotion of Science.

The birefringence of the rod-like liquid crystalline molecule is preferably in a range of 0.001 to 0.7.

The rod-like liquid crystalline molecule preferably has a polymerizable group therein for fixing the orientated state. The polymerizable group is preferably a radical polymerizable unsaturated group or a cationic polymerizable group, and specifically includes, for instance, a polymerizable group and a polymerizable liquid compound which are described in paragraphs [0064] to [0086] in the specification of Japanese Patent Application Laid-Open No. 2002-62427.

(B-3) Disc-Like Liquid Crystalline Molecule

The disc-like (discotic) liquid crystalline molecule includes: a benzene derivative described by C. Destrade et al. in the research report on page 111, Vol. 71, Mol. Cryst. (1981); a truxene derivative described by C. Destrade et al. in the research report on page 141, Vol. 122, Mol. Cryst. (1985) and on page 82, Vol. 78, Physics lett, A. (1990); a cyclohexane derivative described by B. Kohne et al. in the research report on page 70, Vol. 96, Angew. Chem. (1984); and an azacrown-based and a phenylacetylene-based macrocycle described by J. M. Lehn et al. in the research report on page 1794, J. Chem. Commun. (1985) and by J. Zhang et al. in the research report on page 2655, Vol. 116, J. Am. Chem. Soc. (1994).

The disc-like liquid crystalline molecule also includes a compound having a structure of showing liquid crystallinity, in which a straight chain alkyl group, an alkoxy group and a substituted benzoyloxy group substitute side chains of a mother nucleus in the center of the molecule to radially surround the mother nucleus. The molecule or the cluster of the molecules is preferably a compound having a rotation symmetry, to which a fixed orientation can be imparted. A compound which is finally contained in the optically anisotropic layer formed of disc-like liquid crystalline molecules is not necessarily a disc-like liquid crystalline molecule, but also includes, for instance, a compound in which the disc-like liquid crystalline molecules with a low molecular weight have a group that causes a reaction due to heat or light, and are consequently polymerized or cross-linked by heat or light to form a molecule with a high molecular weight and have lost the liquid crystallinity. Preferred examples of the disc-like liquid crystalline molecules are described in Japanese Patent Application Laid-Open No. 8-50206. In addition, the polymerization of the disc-like liquid crystalline molecules is described in Japanese Patent Application Laid-Open No. 8-27284.

In order to fix the disc-like liquid crystalline molecules by the polymerization, it is necessary to bond a polymerizable group to a disc-like core of the disc-like liquid crystalline molecule as a substituent. The disc-like core and the polymerizable group are preferably compounds which are combined with each other through a bonding group. Thereby, the disc-like liquid crystalline molecule can keep the orientated state even in a polymerization reaction. The compounds include, for instance, compounds described in paragraphs [0151] to [0168] in the specification of Japanese Patent Application Laid-Open No. 2000-155216, and the like.

In a hybrid orientation, an angle formed by a long axis (disc face) of the disc-like liquid crystalline molecule and the plane of the polarizing film increases or decreases along with the increase of the distance from the plane of the polarizing film in a depth direction of the optically anisotropic layer. The angle preferably decreases along with the increase of the distance. The way of change in the angle can be continuous increase, continuous decrease, intermittent increase, intermittent decrease, a change including continuous increase and continuous decrease or an intermittent change including increase and decrease. The intermittent change includes a region in which a tilt angle does not change in the middle of the thickness direction. The angle may increase or decrease as a whole, even though a region in which the angle does not change is contained in the middle. Furthermore, the angle preferably changes continuously.

The average direction of the long axes of the disc-like liquid crystalline molecules on the polarizing film side can be generally adjusted by selecting the disc-like liquid crystalline molecule or a material of the orientation film, or by selecting a rubbing treatment method. The direction of the long axes (in disc plane) of the disc-like liquid crystalline molecules in the surface side (air side) can be adjusted generally by selecting the disc-like liquid crystalline molecule or a type of an additive which is used together with the disc-like liquid crystalline molecule. Examples of the additive which is used together with the disc-like liquid crystalline molecule include a plasticizer, a surface-active agent, a polymerizable monomer and a polymer. The degree of the change in the orientated direction of the long axis can be also adjusted by selecting the liquid crystalline molecule and the additive similarly to the above description.

(B-4) Other Composition of Optically Anisotropic Layer

The uniformity of the applied film, the strength of the film, the orientation of the liquid crystalline molecules and the like can be enhanced by concomitantly using the plasticizer, the surface-active agent, the polymerizable monomer and the like together with the above-described liquid crystalline molecule. These compositions preferably have compatibility with the liquid crystalline molecule, and preferably can give the change in the tilt angle to the liquid crystalline molecules or does not hinder the orientation.

The polymerizable monomer includes a radical polymerizable compound and a cationic polymerizable compound. A preferred polymerizable monomer is a polyfunctional radical polymerizable monomer, and is copolymerizable with the above-described liquid crystal compound containing the polymerizable group. The polymerizable monomer includes, for instance, a polymerizable monomer described in paragraphs [0018] to [0020] in the specification of Japanese Patent Application Laid-Open No. 2002-296423. The amount of the above-described compound to be added is generally in a range of 1 to 50 mass % with respect to the amount of the disc-like liquid crystalline molecule, and preferably is in a range of 5 to 30 mass %.

The surface-active agent includes a conventionally well-known compound, and particularly preferably is a fluorine-based compound. Specifically, the surface-active agent includes, for instance, a compound described in paragraphs [0028] to [0056] in the specification of Japanese Patent Application Laid-Open No. 2001-330725.

A polymer which is used together with the disc-like liquid crystalline molecule preferably can give the change in the tilt angle to the disc-like liquid crystalline molecules.

Examples of the polymer can include a cellulose ester. Preferred examples of the cellulose ester include cellulose esters described in the paragraph number [0178] in the specification of Japanese Patent Application Laid-Open No. 2000-155216. In order that the above-described polymer does not hinder the orientation of the liquid crystalline molecules, the amount of the polymer to be added is preferably in a range of 0.1 to 10 mass % with respect to the amount of the liquid crystalline molecule, and more preferably is in a range of 0.1 to 8 mass %.

The transition temperature between a discotic nematic liquid crystal phase and a solid phase of the disc-like liquid crystalline molecule is preferably 70 to 300° C., and more preferably is 70 to 170° C.

(B-5) Formation of Optically Anisotropic Layer

The optically anisotropic layer can be formed by applying an application liquid which contains a liquid crystalline molecule, a polymerizable initiator that will be described later and an arbitrary component, as needed, onto the orientation film.

An organic solvent is preferably used as a solvent to be used when the application liquid is prepared. Examples of the organic solvent include an amide (N,N-dimethylformamide, for instance), a sulfoxide (dimethyl sulfoxide, for instance), a heterocyclic compound (pyridine, for instance), a hydrocarbon (benzene and hexane, for instance), an alkyl halide (chloroform, dichloromethane and tetrachloroethane, for instance), an ester (methyl acetate and butyl acetate, for instance), a ketone (acetone and methyl ethyl ketone, for instance), and an ether (tetrahydrofuran and 1,2-dimethoxyethane, for instance). A preferred organic solvent is an alkyl halide and a ketone. Two or more organic solvents may be concomitantly used.

The application liquid can be applied with a well-known method (a wire bar coating method, an extrusion coating method, a direct gravure coating method, a reverse gravure coating method and a die coating method, for instance).

The thickness of the optically anisotropic layer is preferably 0.1 to 20 μm, further preferably is 0.5 to 15 μm, and most preferably is 1 to 10 μm.

(B-6) Fixation of Orientated State of Liquid Crystalline Molecule

The liquid crystalline molecules which have been orientated can be fixed with maintaining the orientated state. The liquid crystalline molecule is fixed preferably through a polymerization reaction. The polymerization reaction includes a thermal polymerization reaction which uses a thermal polymerization initiator, and a photopolymerization reaction which uses a photopolymerization initiator. The photopolymerization reaction is preferred.

Examples of the photopolymerization initiator include an α-carbonyl compound (described in each specification of U.S. Pat. No. 2,367,661 and U.S. Pat. No. 2,367,670), an acyloin ether (described in specification of U.S. Pat. No. 2,448,828), an α-hydrocarbon-substituted aromatic acyloin compound (described in specification of U.S. Pat. No. 2,722,512), a polynuclear quinone compound (described in each specification of U.S. Pat. No. 3,046,127 and U.S. Pat. No. 2,951,758), a combination of triaryl imidazole dimer and p-aminophenyl ketone (described in specification of U.S. Pat. No. 3,549,367), an acridine compound and a phenazine compound (described in specifications of Japanese Patent Application Laid-Open No. 60-105667 and U.S. Pat. No. 4,239,850), and an oxadiazole compound (described in specification of U.S. Pat. No. 4,212,970).

The amount of the photopolymerization initiator to be used is preferably in a range of 0.01 to 20 mass % of the solid content of the application liquid, and further preferably is in a range of 0.5 to 5 mass %.

Ultraviolet light is preferably used as a light to be used for polymerizing the liquid crystalline molecule by irradiating the liquid crystalline molecule.

The irradiation energy is preferably in a range of 20 mJ/cm² to 50 J/cm², more preferably is in a range of 20 to 5,000 mJ/cm², and further preferably is in a range of 100 to 800 mJ/cm². In order to promote the photopolymerization reaction, the liquid crystalline molecule may be irradiated with light under a heated condition. A protective layer may be provided on the optically anisotropic layer.

It is also preferable to combine this optical compensation film with the polarizing layer. Specifically, the optically anisotropic layer is formed by applying an application liquid for the optically anisotropic layer as described above, onto the surface of the polarizing film. As a result, a thin polarizing plate which has a small stress (distortion×cross-sectional area×modulus of elasticity) due to a dimension change in the polarizing film is produced without providing a polymer film in between the polarizing film and the optically anisotropic layer. When the polarizing plate according to the present invention is provided on a large-sized liquid crystal display, the liquid crystal display device can display an image of high display quality without causing a problem such as light leakage.

The polarizing layer and the optical compensation layer are preferably stretched so that the tilt angle to be formed by the polarizing layer and the optical compensation layer can match an angle to be formed by a transmission axis of two polarizing plates which are laminated on both sides of a liquid crystal cell constituting an LCD and a longitudinal direction or a transverse direction of the crystal cell. A usual tilt angle is 45°. However, LCDs of a transmission type, a reflection type and a translucent type in apparatuses having been developed in recent years have the tilt angle which is not necessarily 45°. Accordingly, a stretching direction is preferably arbitrarily adjusted according to the design of the LCD.

(B-7) Liquid Crystal Display Device

Each liquid crystal mode in which such an optical compensation film is used will be described below.

(TN-Mode Liquid Crystal Display Device)

The TN-Mode Liquid Crystal Display Device is Most Widely Used as a Color TFT liquid crystal display device, and is described in a large number of documents. When the TN mode is in a black display state, the molecules in the liquid crystal cell are in such an orientated state that a rod-like liquid crystalline molecule rises in the central part of the cell, and a rod-like liquid crystalline molecule lies in the vicinity of the substrate of the cell.

(OCB-Mode Liquid Crystal Display Device)

The OCB-mode liquid crystal display device is a liquid crystal cell of a bend orientation mode which make the rod-like liquid crystalline molecules in the upper part and the lower part of the liquid crystal cell orientate in a substantially opposite direction (symmetrically). A liquid crystal display device with the liquid crystal cell in the bend orientation mode is disclosed in each specification of U.S. Pat. No. 4,583,825 and U.S. Pat. No. 5,410,422. Because the rod-like liquid crystalline molecules in the upper part and the lower part of the liquid crystal cell are symmetrically orientated, the liquid crystal cell in the bend orientation mode has an optically self-compensatory function. For this reason, the liquid crystal mode is also referred to as an OCB (Optically Compensatory Bend) liquid crystal mode.

Similarly to the TN mode, when the OCB mode is in a black display state, the molecules in the liquid crystal cell are in such an orientated state that the rod-like liquid crystalline molecule rises in the central part of the cell, and the rod-like liquid crystalline molecule lies in the vicinity of the substrate of the cell.

(VA-Mode Liquid Crystal Display Device)

The VA-mode liquid crystal display device has a feature of making the rod-like liquid crystalline molecules orientate substantially perpendicularly when voltage is not applied. The liquid crystal cell of the VA mode includes: (1) a liquid crystal cell of a VA mode in a narrow sense, which makes the rod-like liquid crystalline molecules orientate substantially perpendicularly when the voltage is not applied, and orientate substantially horizontally when the voltage is applied (described in Japanese Patent Application Laid-Open No. 2-176625); furthermore, (2) a liquid crystal cell (of MVA mode) in which the VA mode is multi-domained for widening a viewing angle (described in SID97, Digest of tech. Papers (proceedings) 28 (1997) 845); (3) a liquid crystal cell of a mode (n-ASM mode) which makes the rod-like liquid crystalline molecules orientate substantially perpendicularly when the voltage is not applied, and orientate in a twisted multi-domain system when the voltage is applied (described in Proceedings 58 to 59 in Japanese Liquid Crystal Symposium (1998)); and (4) a liquid crystal cell of a SURVAIVAL mode (presented in LCD International 98).

(IPS-Mode Liquid Crystal Display Device)

The IPS-mode liquid crystal display device has a feature of making the rod-like liquid crystalline molecules orientate substantially horizontally in the plane when the voltage is not applied, and making the orientation direction of the liquid crystals switched by changing the orientation direction between the presence and the absence of the voltage application. Specifically usable IPS-mode liquid crystal display devices include those described in Japanese Patent Application Laid-Open No. 2004-365941, Japanese Patent Application Laid-Open No. 2004-12731, Japanese Patent Application Laid-Open No. 2004-215620, Japanese Patent Application Laid-Open No. 2002-221726, Japanese Patent Application Laid-Open No. 2002-55341 and Japanese Patent Application Laid-Open No. 2003-195333.

(Other Liquid Crystal Display Devices)

In ECB-mode and STN-mode liquid crystal display devices as well, the liquid crystalline molecules can be optically compensated, in the same concept as in the above-described mode.

(C) Addition of Antireflection Layer (Antireflection Film)

An antireflection film is generally formed by providing a low refractive index layer which is an antifouling layer, and at least one layer (specifically, high refractive index layer and medium refractive index layer) having a higher refractive index than that of the low refractive index layer, on a transparent substrate.

Methods for forming a multilayer film by sequentially stacking transparent thin films of inorganic compounds (metal oxide and the like) having different refractive indices include: a chemical vapor deposition (CVD) method; a physical vapor deposition (PVD) method; and a method of forming a film of colloidal particles of a metal oxide with a sol-gel method using a metal compound such as a metal alkoxide and subjecting the formed film to post treatment to form a thin film (UV irradiation: Japanese Patent Application Laid-Open No. 9-157855, and plasma treatment: Japanese Patent Application Laid-Open No. 2002-327310).

On the other hand, various antireflection films that are formed by applying and stacking thin films in which inorganic particles are dispersed in a matrix are proposed as an antireflection film which can be produced with high productivity.

The antireflection film also includes the one constituted by an antireflection film produced by such an application technique as described above, and by an antireflection layer formed thereon of which the surface of the top layer has a fine concavo-convex shape to acquire antiglare properties.

The thermoplastic film of the present invention can be applied to the above-described any method, but particularly preferably is applied to the method of applying the liquid (application type).

(C-1) Layer Structure of Application Type of Antireflection Film

The antireflection film has a layer structure including at least a medium refractive index layer, a high refractive index layer and a low refractive index layer (outermost layer) in this order on a substrate, and is designed so as to have such refractive indices as to satisfy the following relationship:

refractive index of high refractive index layer>refractive index of medium refractive index layer>refractive index of transparent support member>refractive index of low refractive index layer

The antireflection film may be provided with a hard coating layer in between the transparent support member and the medium refractive index layer. Furthermore, the antireflection film may be formed of the hard coating layer of the medium refractive index, the high refractive index layer and the low refractive index layer.

The examples include Japanese Patent Application Laid-Open No. 8-122504, Japanese Patent Application Laid-Open No. 8-110401, Japanese Patent Application Laid-Open No. 10-300902, Japanese Patent Application Laid-Open No. 2002-243906 and Japanese Patent Application Laid-Open No. 2000-111706.

In addition, each layer may have other functions. The examples include a low refractive index layer having antifouling properties and a high refractive index layer having antistatic properties (Japanese Patent Application Laid-Open No. 10-206603, Japanese Patent Application Laid-Open No. 2002-243906, and the like, for instance).

The haze of the antireflection film is preferably 5% or less, and further preferably is 3% or less. The strength of the film is preferably H or higher according to a pencil hardness test specified in JIS (Japanese Industrial Standards) K5400, further preferably is 2H or higher, and most preferably is 3H or higher.

(C-2) High Refractive Index Layer and Medium Refractive Index Layer

A layer having a high refractive index in the antireflection film is formed of a curable film containing at least ultrafine particles of an inorganic compound, which have an average particle size of 100 nm or less and a high refractive index, and a matrix binder.

The inorganic compound particulate having the high refractive index includes an inorganic compound having a refractive index of 1.65 or more, and preferably having a refractive index of 1.9 or more. The inorganic compound includes, for instance, an oxide of Ti, Zn, Sb, Sn, Zr, Ce, Ta, La, In or the like, and a complex oxide containing these metal atoms.

Methods for forming such ultrafine particles include treating the surface of the particles with a surface treatment agent (silane coupling agent and the like: Japanese Patent Application Laid-Open No. 11-295503, Japanese Patent Application Laid-Open No. 11-153703 and Japanese Patent Application Laid-Open No. 2000-9908; and an anionic compound or an organometallic coupling agent: Japanese Patent Application Laid-Open No. 2001-310432, for instance), producing a core shell structure by using a particle with a high refractive index as a core (Japanese Patent Application Laid-Open No. 2001-166104 and the like), and concomitantly using a particular dispersion agent (Japanese Patent Application Laid-Open No. 11-153703, U.S. Pat. No. 6,210,858B1, Japanese Patent Application Laid-Open No. 2002-2776069 and the like, for instance).

A material which forms a matrix includes a conventionally well-known thermoplastic resin and curable resin film.

Furthermore, preferred materials are a composition containing a polyfunctional compound which contains at least two radical-polymerizable and/or cation-polymerizable groups, and at least one composition selected from an organometallic compound which contains a hydrolyzable group and a composition of a partial condensate thereof. The examples include compounds described in Japanese Patent Application Laid-Open No. 2000-47004, Japanese Patent Application Laid-Open No. 2001-315242, Japanese Patent Application Laid-Open No. 2001-31871, Japanese Patent Application Laid-Open No. 2001-296401 and the like.

In addition, a curable film is also preferable which is obtained from a colloidal metal oxide that is obtained from a hydrolysis condensate of a metal alkoxide, and from a composition of the metal alkoxide. The curable film is described, for instance, in Japanese Patent Application Laid-Open No. 2001-293818, for instance.

The refractive index of the high refractive index layer is generally 1.70 to 2.20. The thickness of the high refractive index layer is preferably 5 nm to 10 μm, and further preferably is 10 nm to 1 μm.

The refractive index of the medium refractive index layer is adjusted so as to be a value in between the refractive index of the low refractive index layer and the refractive index of the high refractive index layer. The refractive index of the medium refractive index layer is preferably 1.50 to 1.70.

### (C-3) Low Refractive Index Layer

The low refractive index layer is formed by sequentially stacking the layer on the high refractive index layer. The refractive index of the low refractive index layer is 1.20 to 1.55. The refractive index is preferably 1.30 to 1.50.

The low refractive index layer is preferably constructed as the outermost layer having scratch resistance and antifouling properties. It is effective to impart slidability to the surface as means for largely enhancing the scratch resistance, and the means of forming a thin film layer to which a conventionally well-known silicon or fluorine is introduced can be applied to the outermost layer.

The refractive index of a fluorine-containing compound is preferably 1.35 to 1.50. The refractive index is more preferably 1.36 to 1.47. The fluorine-containing compound is preferably a compound which contains a cross-linkable or polymerizable functional group that contains a fluorine atom in a range of 35 to 80 mass %.

The fluorine-containing compounds include, for instance, compounds described in paragraphs [0018] to [0026] in the specification of Japanese Patent Application Laid-Open No. 9-222503, paragraphs [0019] to [0030] in the specification of Japanese Patent Application Laid-Open No. 11-38202, paragraphs [0027] to [0028] in the specification of Japanese Patent Application Laid-Open No. 2001-40284, Japanese Patent Application Laid-Open No. 2000-284102 and the like.

A preferred silicon compound is a compound which has a polysiloxane structure and has a curable functional group or a polymerizable functional group in a polymer chain to form a bridged structure in the film. The examples include a reactive silicon (Silaplane made by Chisso Corporation, for instance), and a polysiloxane having a silanol group contained in each of both ends (Japanese Patent Application Laid-Open No. 11-258403 and the like).

The crosslinking or polymerization reaction of a fluorine-containing and/or siloxane-containing polymer having a cross-linkable or polymerizable group is preferably conducted by applying an application composition containing a polymerization initiator, a sensitizer and the like for forming the outermost layer, onto the high refractive index layer, and by irradiating the applied composition with a light or by heating the applied composition, simultaneously with the application or after the application.

A sol-gel cured film is also preferable which is obtained by curing an organometallic compound such as a silane coupling agent with another silane coupling agent that contains a particular fluorine-containing hydrocarbon group, under the coexistence of a catalyst through a condensation reaction.

The examples include a silane compound containing a polyfluoroalkyl group or its partial hydrolysis condensate (compound described in Japanese Patent Application Laid-Open No. 58-142958, Japanese Patent Application Laid-Open No. 58-147483, Japanese Patent Application Laid-Open No. 58-147484, Japanese Patent Application Laid-Open No. 9-157582, Japanese Patent Application Laid-Open No. 11-106704 and the like), and a silyl compound containing a poly“perfluoroalkyl ether” group which is a fluorine-containing long chain group (compound described in Japanese Patent Application Laid-Open No. 2000-117902, Japanese Patent Application Laid-Open No. 2001-48590, Japanese Patent Application Laid-Open No. 2002-53804 and the like).

The low refractive index layer can contain a filler (particulates of inorganic compound such as silicon dioxide (silica) and a fluorine-containing particle (magnesium fluoride, calcium fluoride and barium fluoride) having low refractive index, of which the average diameter of primary particles is 1 to 150 nm, organic particulates described in paragraphs [0020] to [0038] in Japanese Patent Application Laid-Open No. 11-3820, and the like, for instance), a silane coupling agent, a sliding agent and a surface active agent, as an additive other than the above-described compound.

When the low refractive index layer is positioned as a lower layer of the outermost layer, the low refractive index layer may be formed with a gas phase method (vacuum deposition method, sputtering method, ion plating method, plasma CVD method and the like). An application method is preferable in a point of being capable of inexpensively producing the low refractive index layer.

The film thickness of the low refractive index layer is preferably 30 to 200 nm, further preferably is 50 to 150 nm, and most preferably is 60 to 120 nm.

(C-4) Hard Coating Layer

The hard coating layer is provided on the surface of a transparent support member in order to give a physical strength to an antireflection film. The hard coating layer is preferably provided particularly in between the transparent support member and the above-described high refractive index layer.

The hard coating layer is preferably formed through a crosslinking reaction or a polymerization reaction of a compound having properties of curing by light and/or heat.

The above-described curable functional group is preferably a photopolymerizable functional group, and the organometallic compound containing the hydrolyzable functional group is preferably an organic alkoxysilyl compound.

Specific examples of these compounds include the same compound as illustrated in the high refractive index layer.

Specific compositions of the hard coating layer include, for instance, compositions described in Japanese Patent Application Laid-Open No. 2002-144913, Japanese Patent Application Laid-Open No. 2000-9908 and International publication WO 0/46617.

The high refractive index layer can serve as the hard coating layer as well. In such a case, it is preferable to form the hard coating layer by finely dispersing particulates in the matrix with the use of a technique described in the high refractive index layer to make the dispersed particulates contained in the hard coating layer.

The hard coating layer can also serve as an antiglare layer (described later) as well, to which an antiglare function is imparted by making the antiglare layer contain particles having an average particle size of 0.2 to 10 μm.

The film thickness of the hard coating layer can be appropriately designed according to the application. The film thickness of the hard coating layer is preferably 0.2 to 10 μm, and more preferably is 0.5 to 7 μm.

The strength of the hard coating layer is preferably H or higher in a pencil hardness test according to JIS K5400, further preferably is 2H or higher, and most preferably is 3H or higher. In addition, the abrasion loss measured from test pieces before and after the test according to the Taber test specified in JIS K5400 is preferably as little as possible.

(C-5) Forward Scattering Layer

A forward scattering layer is provided so as to give an effect of improving a viewing angle to the member when the audience tilts the viewing angle up, down, right and left in the case where the film is applied to a liquid crystal display device. The forward scattering layer can also function as the above-described hard coating layer as well, if the hard coating layer having particulates with different refractive indices dispersed therein was employed.

The forward scattering layers, for instance, include: the one of which the forward scattering coefficient is specified, which is described in Japanese Patent Application Laid-Open No. 11-38208; the one in which relative refractive indices of a transparent resin and particulates are set in a particular range, which is described in Japanese Patent Application Laid-Open No. 2000-199809; and the one of which the haze value is specified to 40% or more, which is described in Japanese Patent Application Laid-Open No. 2002-107512.

(C-6) Other Layers

A primer layer, an antistatic layer, an under-coating layer, a protective layer and the like other than the above-described layers may be provided on the transparent support member.

(C-7) Application Method

Each layer in an antireflection film can be formed by applying each composition onto the layer with a dip coating method, an air-knife coating method, a curtain coating method, a roller coating method, a wire-bar coating method, a gravure coating method, a microgravure method and an extrusion coating method (the specification of U.S. Pat. No. 2,681,294).

(C-8) Antiglare Function

The antireflection film may also have an antiglare function which scatters a light from the outside. The antireflection film can obtain the antiglare function by forming convexo-convex on its surface. When the antireflection film has the antiglare function, the haze of the antireflection film is preferably 3 to 30%, further preferably is 5 to 20% and most preferably is 7 to 20%.

Any method can be employed as a method for forming the convexo-convex on the surface of the antireflection film, as long as the method can sufficiently retain these surface shapes. The examples include: a method of forming the convexo-convex on the surface of the film by adding particulates in a low refractive index layer (Japanese Patent Application Laid-Open No. 2000-271878 and the like, for instance); a method of forming a surface-concavo-convex film by adding a small amount (0.1 to 50 mass %) of comparatively large particles (particle sizes of 0.05 to 2 μm) to the lower layer (high refractive index layer, medium refractive index layer or hard coating layer) of the low refractive index layer, and forming a low refractive index layer on the film while maintaining these shapes (Japanese Patent Application Laid-Open No. 2000-281410, Japanese Patent Application Laid-Open No. 2000-95893, Japanese Patent Application Laid-Open No. 2001-100004, Japanese Patent Application Laid-Open No. 2001-281407 and the like, for instance); and a method of forming the top layer (antifouling layer) by physically transcribing an concavo-convex shape onto the surface of the top layer after the top layer is coated (embossing method, for instance, described in Japanese Patent Application Laid-Open No. 63-278839, Japanese Patent Application Laid-Open No. 11-183710, Japanese Patent Application Laid-Open No. 2000-275401 and the like).

### EXAMPLES

### (1) Cycloolefin Resin

(i) Cycloolefin Resin-A (Ring-Opened Polymer)

A polymer solution was obtained by: adding 10 parts of a 15% cyclohexane solution of triethylaluminum, 5 parts of triethylamine, and 10 parts of a 20% cyclohexane solution of titanium tetrachloride which are solutions of polymerization catalyst, to 6-methyl-1,4,5,8-dimethanol-1,4,4a,5,6,7,8,8a-octahydronaphthalene; ring-opening polymerizing the compounds in cyclohexane; and hydrogenating the obtained ring-opened polymer with a nickel catalyst. A powdery resin was obtained by solidifying the polymer solution in isopropyl alcohol, and drying the solid. The number average molecular weight of the resin was 40,000, the hydrogenation ratio was 99.8% or more, and the Tg was 139° C.

(ii) Cycloolefin Resin-B (Ring-Opened Polymer)

A solution was prepared by charging 100 parts by mass of 8-methyl-8-methoxycarbonyltetracyclo[4.4.0.12.5, 17.10]-3-dodecene (specific monomer B), 150 parts by mass of 5-(4-biphenyl carbonyloxy)bicyclo[2.2.1]hept-2-ene (specific monomer A), 18 parts of 1-hexene (molecular weight modifier) and 750 parts by mass of toluene into a reaction vessel of which the inside was replaced with nitrogen, and was heated to 60° C. Subsequently, a solution of a ring-opened polymer was obtained by: adding 0.62 parts by mass of a toluene solution of triethylaluminum (1.5 mol/l) and 3.7 parts by mass of a toluene solution (concentration of 0.05 mol/l) of tungsten hexachloride (t-butanol: methanol: tungsten=0.35 mol: 0.3 mol: 1 mol) which has been modified by t-butanol and methanol, which are a polymerization catalyst, to the solution in the reaction vessel; and heating and stirring the system at 80° C. for 3 hours to cause a ring-opening-polymerization reaction therein. The polymerization conversion ratio in the polymerization reaction was 97%, and the intrinsic viscosity (ηinh) of the obtained ring-opened polymer, which had been measured in chloroform at 30° C., was 0.65 dl/g.

A solution was prepared by charging 4,000 parts by mass of thus obtained solution of the ring-opened polymer into an autoclave and adding 0.48 parts of RuHCl(CO)[P(C₆H₅)₃]₃ to the solution, and was heated and stirred for 3 hours on conditions of a hydrogen gas pressure of 100 kg/cm² and a reaction temperature of 165° C. to cause the hydrogenation reaction therein. The obtained reaction solution (solution of hydrogenated polymer) was cooled, and then the pressure of hydrogen gas was released. A hydrogenated polymer (specific cyclic polyolefin-based resin) was obtained by charging the reaction solution into a large amount of methanol, separating and collecting the coagulum, and drying the coagulum. As a result of having measured the hydrogenation ratio to olefinic unsaturated bonds of thus obtained hydrogenated polymer with the use of 400 MHz and ¹H-NMR, the measured value was 99.9%. As a result of having measured the number average molecular weight (Mn) and weight average molecular weight (Mw) in terms of polystyrene with a GPC method (solvent: tetrahydrofuran), the number average molecular weight (Mn) was 39,000, the weight average molecular weight (Mw) was 126,000, and the molecular weight dispersion (Mw/Mn) was 3.23. In addition, the Tg was 110° C.

(iii) Cycloolefin Resin-C (Addition Polymer)

A cycloolefin compound described in Example 2 of Japanese Patent Application Laid-Open No. 2005-330465 (Tg of 127° C.)

(iv) Cycloolefin Resin-D (Addition Polymer)

A cycloolefin compound (Tg of 181° C.) described in Example 1 of Japanese National Publication of International Patent Application No. 8-507800

(v) Cycloolefin Resin-E (Addition Polymer)

APL6015T (Tg of 145° C.) made by Mitsui Chemicals, Inc.

(vi) Saturated Norbornene Resin-F (Addition Polymer)

TOPAS6013 (Tg of 130° C.) made by Polyplastics Co., Ltd.

(vii) Cycloolefin Resin-G (Addition Polymer)

A cycloolefin compound (Tg of 140° C.) described in Example 1 of Japanese Patent No. 3693803

### (2) Film Formation

The above-described cycloolefin resins A to G were molded as a cylindrical pellet having the average diameter of 3 mm and the average length of 5 mm.

The pellet was dried in a vacuum dryer at 110° C. to control the water content to 0.1% or less, and then was charged into a hopper which has been adjusted to a temperature of Tg−10° C.

The pellet was melted in a kneading extruder at 260° C. Then, the melt which had been fed from a gear pump was filtrated through a leaf disc filter having a filtering accuracy of 5 μm.

After this, the melt (melted resin) was extruded onto a casting roll (CR) through a hanger coat die of 260° C. with a slit space of 1.0 mm. Molecular orientation treatment was conducted on the film by stretching the film in a longitudinal direction when the melt was cast.

### (3) Stretching and Relaxation

The cycloolefin film obtained in the above-described melting and film-forming steps was stretched and relaxed.

Table 1 is a list which summarizes the results of a stretch ratio, a roll temperature, a heater type, presence or absence of an embossing process, optical properties, a wound shape and a total evaluation on Examples (1 to 7) and Comparative Example (1) in the present invention. Here, the optical properties mean a value of retardation (Rth) which was developed in a longitudinal stretching operation in a casting step.

As is clear from the Table, in Comparative Example 1 which was not stretched, the base ruptured and the film could not be wound. In addition, in several Examples, Examples which were subjected to the embossing process tended to acquire higher total evaluation. In addition, in several Examples, Examples having a developed retardation (Rth) of 50 nm or less tended to acquire higher total evaluation.

TABLE 1

| | | Roll | | | Optical | | |
|---|---|---|---|---|---|---|---|
| | Stretch | temperature | | Embossing | properties | Rolled | Total |
| | ratio | (° C.) | Heater type | process | (nm) | shape | evaluation |
| Example 1 | 1.1 | Tg + 15 | Far-infrared | Presence | 5 | B | A |
| | | | heater | (heating) | | | |
| Example 2 | 1.5 | Tg + 50 | Far-infrared | Presence | 10 | B | A |
| | | | heater | (heating) | | | |
| Example 3 | 2.2 | Tg + 150 | Far-infrared | Presence | 30 | B | B |
| | | | heater | (heating) | | | |
| Example 4 | 1.2 | Tg + 20 | Far-infrared | Absence | 6 | C | B |
| | | | heater | | | | |
| Example 5 | 2.7 | Tg + 170 | Far-infrared | Presence | 70 | B | C |
| | | | heater | (heating) | | | |
| Example 6 | 1.4 | Tg + 220 | No heater | Presence | 60 | B | C |
| | | | | (heating) | | | |
| Example 7 | 1.2 | Tg + 30 | Far-infrared | Presence | 55 | C | C |
| | | | heater | (cold | | | |
| | | | | embossing) | | | |
| Comparative | — | None | No heater | Presence | 3 | D | D |
| Example 1 | | | | (hot | | | |
| | | | | embossing) | | | |

### (4) Production of Polarizing Plate

The surface of the film of any level was subjected to corona treatment so that the contact angle of the surface with the water on the surface can be 60°. A polarizing layer having the thickness of 20 μm was produced by being stretched in a longitudinal direction between two pairs of nip rolls to which respectively different peripheral speeds are given, according to Example 1 of Japanese Patent Application Laid-Open No. 2001-141926.

A polarizing plate was produced by laminating the films so as to form the following structure, while using a 3% solution of PVA (PVA-117H made by Kuraray Co., Ltd.) as an adhesive.

Polarizing plate E: cycloolefin film/polarizing layer/FUJITAC

Thus obtained polarizing plate was attached to a 50-inch VA type of liquid crystal display device in place of its polarizing plate, which had been produced according to FIGS. 2 to 9 of Japanese Patent Application Laid-Open No. 2000-154261. The polarizing plate which had been produced according to the present invention caused no planar failure and showed good performance. In particular, an addition polymerization type of cycloolefin film was good.

### (5) Production of Optical Compensation Film

The cycloolefin film according to the present invention was used in place of a cellulose acetate film to which a liquid composition for a liquid crystal layer of Example 1 in Japanese Patent Application Laid-Open No. 11-316378 had been applied. The film produced according to the present invention showed good performance. In particular, an addition polymerization type of cycloolefin film was good.

An optical compensation film produced by using the cycloolefin film according to the present invention in place of the cellulose acetate film to which a liquid composition for the liquid crystal layer of Example 1 in Japanese Patent Application Laid-Open No. 7-333433 was applied also similarly showed good performance. In particular, the addition polymerization type of cycloolefin film was good.

### (6) Production of Low Reflection Film

A low reflection film was produced from the cycloolefin film of the present invention, according to Example 47 in Journal of Technical Disclosure by the Japan Institute of Invention and Innovation (Technical Disclosure No. 2001-1745). As a result, the low reflection film showed good optical performance. In particular, the addition polymerization type of cycloolefin film was good.

### (7) Production of Liquid Crystal Display Element

The polarizing plate in the present invention was used for a liquid crystal display device described in Example 1 of Japanese Patent Application Laid-Open No. 10-48420, an optically anisotropic layer containing discotic liquid crystal molecules described in Example 1 of Japanese Patent Application Laid-Open No. 9-26572 and an orientation film to which polyvinyl alcohol was applied, a 50-inch VA type of liquid crystal display device produced according to the description of FIGS. 2 to 9 in Japanese Patent Application Laid-Open No. 2000-154261, a 50-inch OCB type of liquid crystal display device produced according to FIGS. 10 to 15 in Japanese Patent Application Laid-Open No. 2000-154261, and an IPS type of liquid crystal display device described in FIG. 11 in Japanese Patent Application Laid-Open No. 2004-12731. Furthermore, the low reflection film in the present invention was attached on the top layer of these liquid crystal display devices, and was evaluated. As a result, a good liquid crystal display element was obtained. In particular, the addition polymerization type of cycloolefin film was good.

1. A method for producing a cycloolefin resin film comprising the steps of:
melt-extruding a cycloolefin resin into a form of a film from a die, at an extrusion temperature of 230 to 260° C. and a melt viscosity of 500 to 3,000 Pa·s;
casting the melt-extruded film;
applying a molecular orientation treatment to the melt-extruded film;
winding the cast film after the molecular orientation treatment; and
unwinding the wound film and stretching the film in a longitudinal direction and/or a transverse direction to develop retardation therein.

2. The method for producing a cycloolefin resin film according to claim 1, wherein the step of applying molecular orientation treatment includes a step of stretching the melted-extruded film at a stretch ratio of 1.05 to 2.5 times in the longitudinal direction.

3. The method for producing a cycloolefin resin film according to claim 2, wherein the stretching of a film in the longitudinal direction is conducted in the casting step.

4. The method for producing a cycloolefin resin film according to claim 3, wherein the stretching of the film in the longitudinal direction comprises heating the melt-extruded film with a heating roller whose temperature is in a range of Tg+10 to Tg+200° C.

5. The method for producing a cycloolefin resin film according to claim 4, wherein a temperature distribution in a width direction of the heating roller is within ±2° C.

6. The method for producing a cycloolefin resin film according to claim 1, further comprising
further heating the melt-extruded film with a far-infrared heater.

7. The method for producing a cycloolefin resin film according to claim 1, further comprising
an embossing step of further imparting an embossed pattern having a height in a range of 5 to 20% of a thickness of the film, to the film which has been subjected to the molecular orientation treatment.

8. The method for producing a cycloolefin resin film according to claim 7, wherein the embossing step includes a step of imparting an embossed pattern to the film by heating an embossing roller to a temperature range of Tg+10 to Tg+200° C.

9. The method for producing a cycloolefin resin film according to claim 8, wherein the embossing roller is heated by a heater.

10. The method for producing a cycloolefin resin film according to claim 9, wherein the heater is an infrared heater or a dielectric-heating heater.

11. The method for producing a cycloolefin resin film according to claim 1, further comprising
supporting the film by the pass roller of which a surface roughness (Ra) is 1 μm or less.

12. The method for producing a cycloolefin resin film according to claim 1, wherein the step of casting the melt-extruded film is performed by any one of a touch roll system, an air chamber system, a vacuum nozzle system, an electrostatic application system and an air knife system.

13. The method for producing a cycloolefin resin film according to claim 1, wherein the step of casting the melt-extruded film comprises casting the film with a casting drum having a surface roughness (Ra) of 30 μm or less.

14. A cycloolefin resin film wherein the film is produced by the process according to claim 1.
